(19) United States
(12) Patent Application Publication
(10) Pub. No.: US 2009/0240834 A1
(43) Pub. Date: Sep. 24, 2009

(54) MANAGEMENT APPARATUS, COMMUNICATION PATH CONTROL METHOD, COMMUNICATION PATH CONTROL SYSTEM, AND COMPUTER-READABLE STORAGE MEDIUM

(75) Inventor: Mitsuru Otsuka, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/399,788

(22) Filed: Mar. 6, 2009

(30) Foreign Application Priority Data
Mar. 18, 2008 (JP) 2008-070052

(51) Int. Cl. G06F 15/173

(52) U.S. Cl. 709/239

(57) ABSTRACT

A management apparatus manages relay apparatus information about communication of a relay apparatus, and connection information about a relay apparatus to which a communication apparatus is connected, and controls change of a communication path between communication apparatuses based on information including the relay apparatus information and the connection information.

### BACKGROUND OF THE INVENTION

1. Field of the Invention

The present invention relates to communication performed between communication apparatuses via a relay apparatus.

2. Description of the Related Art

Wireless LAN (Local Ares Network) products based on the IEEE standards are widely used in recent years. As the connection forms of wireless LAN, an infrastructure mode including a plurality of stations (communication apparatuses) and access points (relay apparatuses), and an ad hoc mode including only a plurality of stations are known. Concerning this technique, a WDS (Wireless Distribution System) using wireless communication between access points and a mesh network formed using a plurality of ad hoc direct communications between stations are also known. Note that the IEEE802.11 standard does not define any detailed relay method for the WDS.

A communication path control technique is known, which determines whether traffic to a specific wireless base station has exceeded a threshold. If the traffic is distributable, an instruction for communication path switching is given (Japanese Patent Laid-Open No. 2000-69050).

In another known technique, the transmission channel bandwidth is checked before sending a packet to an access point. Then, address information in use of path information is updated based on the check result (Japanese Patent Laid-Open No. 2001-119435).

There is known still another technique which inhibits connection of a new station if the number of connected stations is equal to or larger than the maximum connection count, or the communication bandwidth in use of the station is smaller than the minimum communication bandwidth (Japanese Patent Laid-Open No. 2003-101551).

Still another known technique determines a communication path based on cost information obtained by calculating a node cost corresponding to the degree of congestion of a wireless base station and a link cost corresponding to the wireless state of a link (Japanese Patent Laid-Open No. 2005-303827).

The above-described techniques have various problems. For example, there is not proposed any technique of promoting the efficiency of communication resource utilization by decreasing the number of access points to pass (decreasing the number of communication paths) or the number of frequency channels to be used on the communication paths between the stations via the access points.

### SUMMARY OF THE INVENTION

The present invention enables increasing the speed of communication between communication apparatuses by controlling a communication path which passes through relay apparatuses between the communication apparatuses.

According to a first aspect of the present invention, there is provided a management apparatus for managing a plurality of relay apparatuses and a plurality of communication apparatuses which communicate via the relay apparatuses, comprising: a first management unit configured to manage relay apparatus information about communication of each of the relay apparatuses; a second management unit configured to manage connection information about connection between each of the communication apparatuses and a relay apparatus to which the communication apparatus is connected; and a control unit configured to control change of a communication path between the communication apparatuses based on information including the relay apparatus information managed by the first management unit and the connection information managed by the second management unit.

According to a second aspect of the present invention, there is provided a communication path control method of a management apparatus for managing a plurality of relay apparatuses and a plurality of communication apparatuses which communicate via the relay apparatuses, comprising: managing relay apparatus information about communication of each of the relay apparatuses; managing connection information about connection between each of the communication apparatuses and a relay apparatus to which the communication apparatus is connected; and controlling change of a communication path between the communication apparatuses based on information including the relay apparatus information and the connection information.

According to a third aspect of the present invention, there is provided a communication path control system including a plurality of relay apparatuses, a plurality of communication apparatuses which communicate via the relay apparatuses, and a management apparatus, the management apparatus comprising: a first management unit configured to manage relay apparatus information about communication of each of the relay apparatuses; a second management unit configured to manage connection information about connection between each of the communication apparatuses and a relay apparatus to which the communication apparatus is connected; and a control unit configured to control change of a communication path between the communication apparatuses based on information including the relay apparatus information managed by the first management unit and the connection information managed by the second management unit.

According to a fourth aspect of the present invention, there is provided a computer-readable storage medium storing a communication path control program which causes a computer incorporated in a management apparatus for managing a plurality of relay apparatuses and a plurality of communication apparatuses which communicate via the relay apparatuses to function as: a first management unit configured to manage relay apparatus information about communication of each of the relay apparatuses; a second management unit configured to manage connection information about connection between each of the communication apparatuses and a relay apparatus to which the communication apparatus is connected; and a control unit configured to control change of a communication path between the communication apparatuses based on information including the relay apparatus information managed by the first management unit and the connection information managed by the second management unit.

Further features of the present invention will become apparent from the following description of exemplary embodiments with reference to the attached drawings.

### BRIEF DESCRIPTION OF THE DRAWINGS

FIG. 1 is a view showing an example of the overall arrangement of a communication path control system according to an embodiment of the present invention;

FIG. 2 is a block diagram showing an example of the functional arrangement of a relay apparatus 20 shown in FIG. 1;

FIG. 3 is a block diagram showing an example of the functional arrangement of a communication apparatus 10 shown in FIG. 1;

FIG. 4 is a block diagram showing an example of the functional arrangement of a management apparatus 30 shown in FIG. 1;

FIG. 5 is a first sequence chart showing an example of the sequence of the operation of communication path control processing in the communication path control system shown in FIG. 1;

FIG. 6 is a view showing an example of a relay apparatus information registration message;

FIG. 7 is a view showing an example of relay apparatus information;

FIG. 8 is a view showing an example of a connection information registration message;

FIG. 9 is a view showing an example of connection information;

FIG. 10 is a view showing an example of a communication path efficiency promotion request message;

FIG. 11 is a view showing an example of a communication path efficiency promotion response message;

FIG. 12 is a view showing an example of communication information;

FIG. 13 is a second sequence chart showing an example of the sequence of the operation of communication path control processing in the communication path control system shown in FIG. 1;

FIG. 14 is a view showing an example of a relay apparatus information registration message;

FIG. 15 is a view showing an example of relay apparatus information;

FIG. 16 is a view showing an example of a connection information registration message;

FIG. 17 is a view showing an example of connection information;

FIG. 18 is a view showing an example of a communication path efficiency promotion request message;

FIG. 19 is a view showing an example of communication information;

FIG. 20 is a third sequence chart showing an example of the sequence of the operation of communication path control processing in the communication path control system shown in FIG. 1;

FIG. 21 is a view showing an example of a relay apparatus information registration message;

FIG. 22 is a view showing an example of relay apparatus information;

FIG. 23 is a view showing an example of a connection information registration message;

FIG. 24 is a view showing an example of connection information;

FIG. 25 is a view showing an example of a communication path efficiency promotion response message;

FIG. 26 is a view showing an example of a connection change instruction message;

FIG. 27 is a view showing an example of connection information;

FIG. 28 is a fourth sequence chart showing an example of the sequence of the operation of communication path control processing in the communication path control system shown in FIG. 1;

FIG. 29 is a view showing an example of a connection change instruction message;

FIGS. 30A and 30B are fifth sequence charts showing an example of the sequence of the operation of communication path control processing in the communication path control system shown in FIG. 1;

FIG. 31 is a view showing an example of a communication information registration message;

FIG. 32 is a view showing an example of a connection information registration message;

FIG. 33 is a view showing an example of a communication path efficiency promotion request message;

FIG. 34 is a view showing an example of communication information;

FIG. 35 is a view showing an example of connection information;

FIGS. 36A and 36B are sixth sequence charts showing an example of the sequence of the operation of communication path control processing in the communication path control system shown in FIG. 1;

FIG. 37 is a view showing an example of a relay apparatus information registration message;

FIG. 38 is a view showing an example of relay apparatus information;

FIG. 39 is a view showing an example of a connection information registration message;

FIG. 40 is a view showing an example of connection information;

FIG. 41 is a view showing an example of a communication information registration message;

FIG. 42 is a view showing an example of communication information;

FIG. 43 is a view showing an example of a connection change instruction message;

FIG. 44 is a view showing an example of communication information;

FIG. 45 is a view showing an example of connection information;

FIG. 46 is a flowchart illustrating the operation of the relay apparatus 20 shown in FIG. 1;

FIG. 47 is a flowchart illustrating the operation of the communication apparatus 10 shown in FIG. 1;

FIG. 48 is a flowchart illustrating the operation of connection change processing in step S4708 in FIG. 47;

FIG. 49 is a flowchart illustrating the operation of the management apparatus 30 shown in FIG. 1;

FIGS. 50A and 50B are flowcharts illustrating the operation of communication path determination processing in step S4906 in FIG. 49;

FIG. 51 is a flowchart illustrating the operation of first communication path determination processing in step S5004 in FIG. 50B;

FIG. 52 is a flowchart illustrating the operation of second communication path determination processing in step S5009 in FIG. 50B; and

FIG. 53 is a flowchart illustrating the operation of third communication path determination processing in step S5011 in FIG. 50A.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

In the following embodiment, an example will be described in which communication paths between communication apparatuses in a wireless LAN network are controlled. However, the present invention is also applicable to a wired network.

### Embodiment

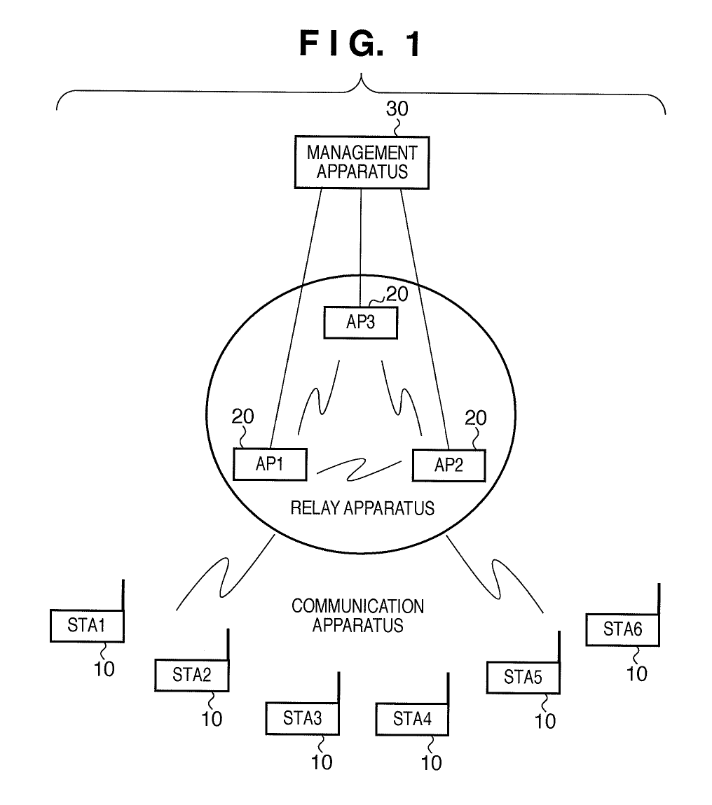

FIG. 1 is a view showing an example of the overall arrangement of a communication path control system according to an embodiment of the present invention.

A plurality of communication apparatuses (STA1 to STA6) 10, a plurality of relay apparatuses (AP1 to AP3) 20, and a management apparatus 30 are connected to the communication path control system via a wireless LAN network.

Each of the communication apparatuses (STA1 to STA6) 10 is connected to one of the relay apparatuses (AP1 to AP3) 20 to form communication paths between the communication apparatuses. The management apparatus 30 manages information to be used to form the communication paths and controls communication path change between the communication apparatuses based on the information. The information managed by the management apparatus 30 includes, for example, information (relay apparatus information) about the relay apparatuses in the network, information (connection information) about connection between the communication apparatuses and the relay apparatuses, and information (communication information) about communication between the communication apparatuses.

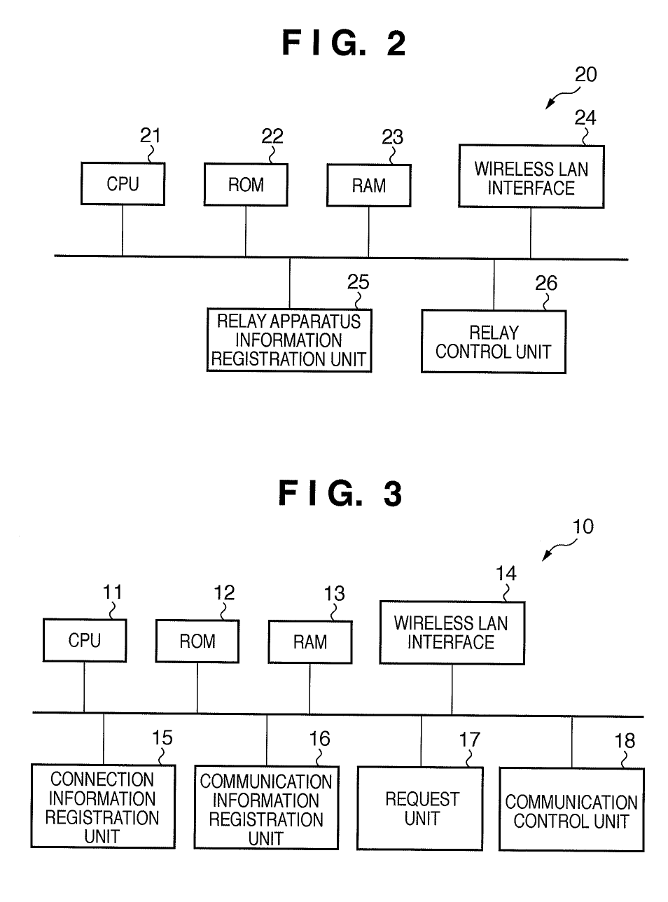

FIG. 2 is a block diagram showing an example of the functional arrangement of the relay apparatus 20 shown in FIG. 1.

The relay apparatus 20 includes a CPU (Central Processing Unit) 21, ROM (Read Only Memory) 22, RAM (Random Access Memory) 23, wireless LAN interface 24, relay apparatus information registration unit 25, and relay control unit 26. The CPU 21 comprehensively controls the operation of the relay apparatus 20. The RAM 23 is used as the work area of the CPU 21. The ROM 22 stores control programs to be executed by the CPU 21. The wireless LAN interface 24 provides a wireless LAN communication function. The relay apparatus information registration unit 25 registers, in the management apparatus 30, relay apparatus information about wireless communication of the relay apparatus. The relay control unit 26 controls the communication relay operation between the communication apparatuses.

FIG. 3 is a block diagram showing an example of the functional arrangement of the communication apparatus 10 shown in FIG. 1.

The communication apparatus 10 includes a CPU 11, ROM 12, RAM 13, wireless LAN interface 14, connection information registration unit 15, communication information registration unit 16, request unit 17, and communication control unit 18. The CPU 11 comprehensively controls the operation of the communication apparatus 10. The RAM 13 is used as the work area of the CPU 11. The ROM 12 stores control programs to be executed by the CPU 11. The wireless LAN interface 14 provides a wireless LAN communication function. The connection information registration unit 15 registers, in the management apparatus 30, connection information about connection between the communication apparatus 10 and a relay apparatus 20. The communication information registration unit 16 registers, in the management apparatus 30, communication information about communication between communication apparatuses. The request unit 17 requests the management apparatus 30 to promote the efficiency of the communication paths between the communication apparatuses. The communication control unit 18 controls communication processing of the communication apparatus 10.

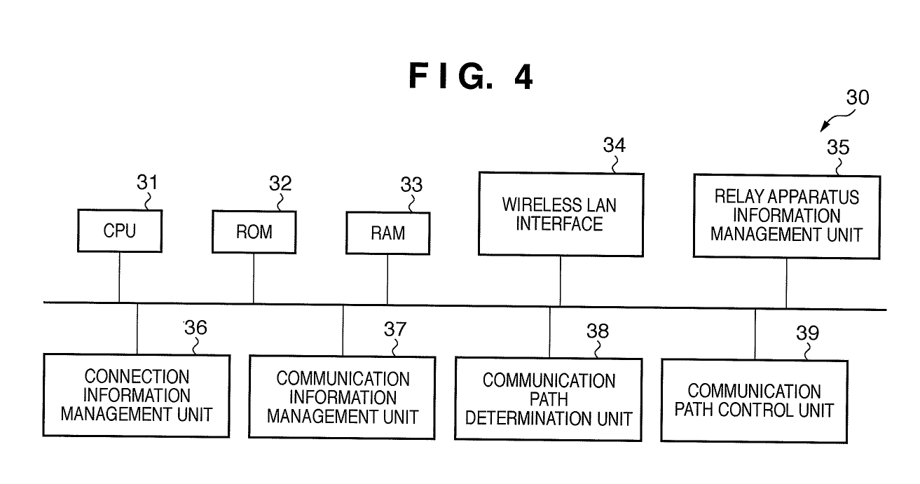

FIG. 4 is a block diagram showing an example of the functional arrangement of the management apparatus 30 shown in FIG. 1.

The management apparatus 30 includes a CPU 31, ROM 32, RAM 33, wireless LAN interface 34, relay apparatus information management unit 35, connection information management unit 36, communication information management unit 37, communication path determination unit 38, and communication path control unit 39. The CPU 31 comprehensively controls the operation of the management apparatus 30. The RAM 33 is used as the work area of the CPU 31. The ROM 32 stores control programs (e.g., a communication path control program) to be executed by the CPU 31. The wireless LAN interface 34 provides a wireless LAN communication function. The relay apparatus information management unit 35 manages relay apparatus information sent from each relay apparatus 20. The connection information management unit 36 manages connection information sent from each communication apparatus 10. The communication information management unit 37 manages communication information about communication between the communication apparatuses. Note that the relay apparatus information, connection information, and communication information are stored in, for example, the RAM 33 and managed. The communication path determination unit 38 determines whether to change the communication path between communication apparatuses. The communication path determination unit 38 determines the communication path change based on, for example, the number of relay apparatuses on the communication paths between the communication apparatuses, the number of channels of each relay apparatus, and the frequency bandwidth (to be referred to as a communication bandwidth hereinafter) usable by each relay apparatus. Note that the communication path determination unit 38 also determines whether it is possible to reduce the number of channels used in a relay apparatus 20 on a communication path. The communication path control unit 39 controls the communication path change between communication apparatuses based on the determination result (and also controls to reduce the number of channels used in the relay apparatus 20).

The functional arrangements of the apparatuses have been described above with reference to FIGS. 2 to 4. The functional arrangements can partially or wholly be implemented either by hardware or by causing the CPU to read out and execute programs and data stored in the ROM or the like.

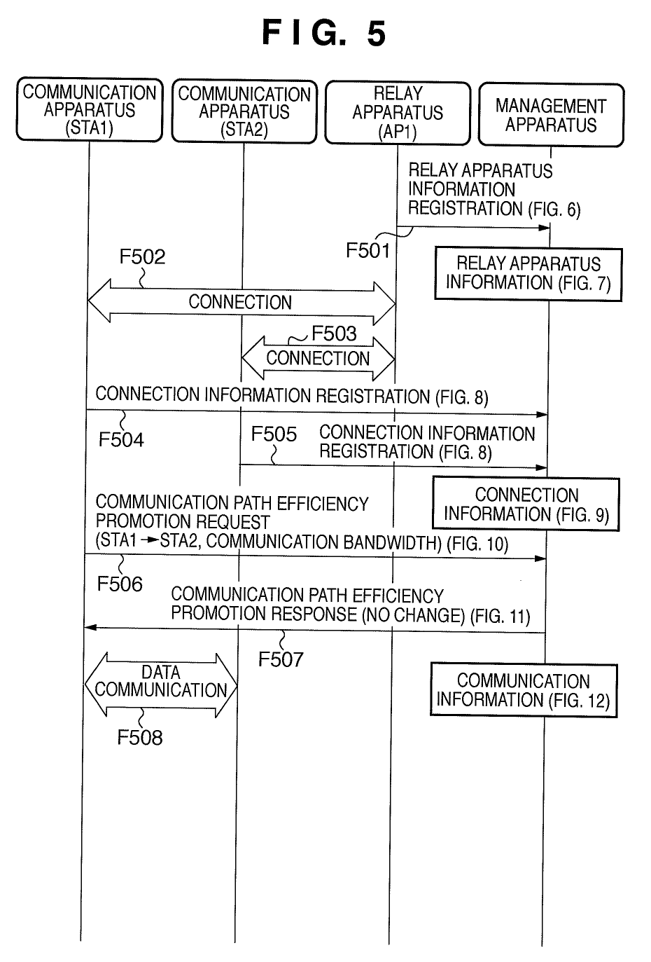

The sequence of the operation of communication path control processing in the communication path control system shown in FIG. 1 will be described with reference to FIGS. 5 to 45 using several examples.

FIG. 5 shows the sequence of processing of causing the communication apparatus (STA1) 10 to communicate with the communication apparatus (STA2) 10 via the relay apparatus (AP1) 20. An example will be explained in which the communication path does not change.

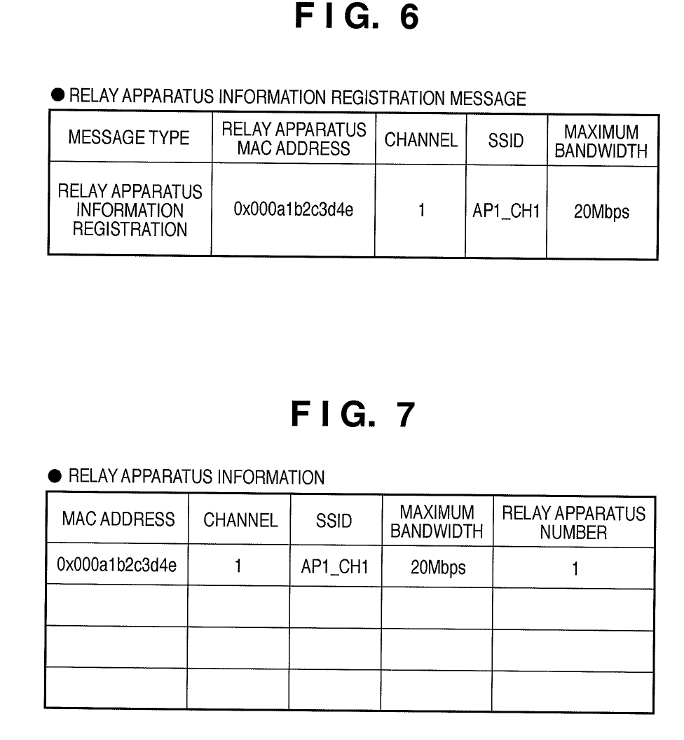

When the processing starts, the relay apparatus (AP1) 20 registers information about wireless communication of itself, that is, relay apparatus information in the management apparatus 30. In the relay apparatus information registration processing, the relay apparatus 20 sends a relay apparatus information registration message to the management apparatus 30 (F501). FIG. 6 shows an example of the data structure of the relay apparatus information registration message. The relay apparatus information registration message includes a message type, the MAC address of the relay apparatus (relay apparatus identification information), the frequency channel and SSID used in wireless communication of the relay apparatus, and the maximum bandwidth allocatable to wireless communication of the relay apparatus. The relay apparatus information registration message shown in FIG. 6 sets “relay apparatus information registration” in the message type, “0x000a1b2c3d4e” in the MAC address of the relay apparatus, “1” in the frequency channel, “AP1_CH1” in the SSID, and “20 Mbps” in the maximum bandwidth.

Upon receiving the relay apparatus information registration message, the management apparatus 30 updates, based on the message, relay apparatus information managed by the relay apparatus information management unit 35. FIG. 7 shows an example of relay apparatus information updated based on the relay apparatus information registration message shown in FIG. 6. Relay apparatus information includes the MAC address of the relay apparatus, the frequency channel and SSID used in wireless communication of the relay apparatus, and the maximum bandwidth allocatable to wireless communication of the relay apparatus. The relay apparatus information also includes a relay apparatus number to associate a plurality of frequency channels of a relay apparatus. The relay apparatus information need not always include all pieces of information described above, and can include at least one of them. This also applies to other pieces of information.

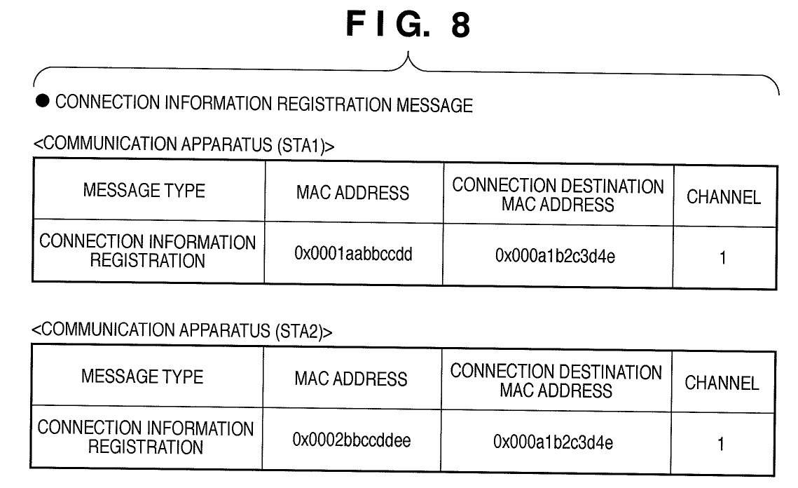

The communication apparatuses (STA1 and STA2) are connected to the relay apparatus (AP1) 20 (F502 and F503). When connection to the relay apparatus (AP1) 20 is done, each of the communication apparatuses (STA1 and STA2) registers connection information in the management apparatus 30 (F504 and F505). In the connection information registration processing, each communication apparatus 10 sends a connection information registration message to the management apparatus 30. FIG. 8 shows an example of the data structure of the connection information registration message. The connection information registration message includes a message type, the MAC address of the communication apparatus (communication apparatus identification information), the MAC address of the connection destination relay apparatus (connection destination relay apparatus identification information), and the frequency channel used in wireless communication of the relay apparatus. FIG. 8 shows the connection information registration messages of the communication apparatuses (STA1 and STA2). More specifically, as the connection information of the communication apparatus (STA1) 10, the message sets “0x0001aabbccdd” in the MAC address of the communication apparatus, “0x000a1b2c3d4e” in the MAC address of the connection destination relay apparatus, and “1” in the frequency channel. As the connection information of the communication apparatus (STA2) 10, the message sets “0x0002bbccddee” in the MAC address of the communication apparatus, “0x000a1b2c3d4e” in the MAC address of the connection destination relay apparatus, and “1” in the frequency channel. Note that “connection information registration” is set in the message type.

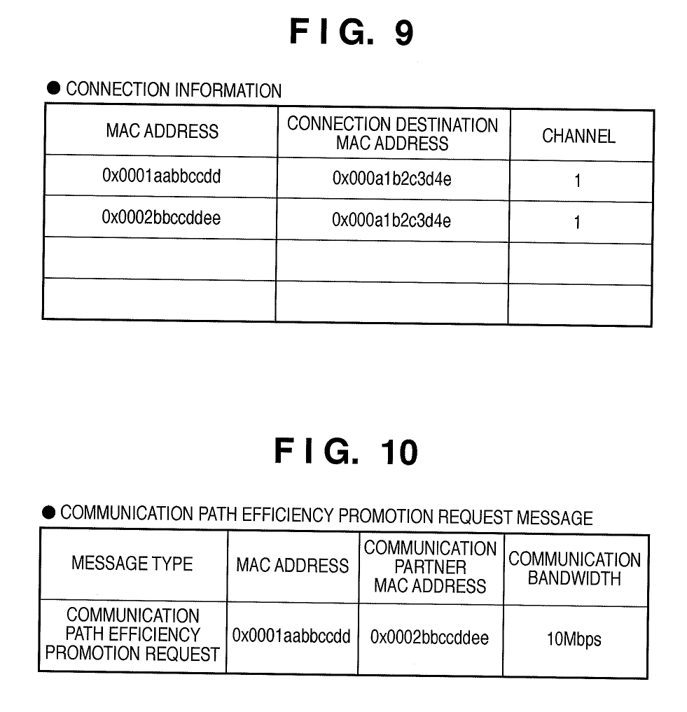

Upon receiving the connection information registration messages, the management apparatus 30 updates, based on the messages, connection information managed by the connection information management unit 36. FIG. 9 shows an example of connection information updated based on the connection information registration messages shown in FIG. 8. As shown in FIG. 9, connection information includes the MAC address of the communication apparatus, the MAC address of the connection destination relay apparatus, and the frequency channel used in wireless communication of the relay apparatus.

The communication apparatus (STA1) 10 transmits a communication path efficiency promotion request message (to be also abbreviated as an efficiency promotion request message hereinafter) to the management apparatus 30 prior to the start of data communication with the communication apparatus (STA2) 10 (F506). FIG. 10 shows an example of the data structure of the efficiency promotion request message. The message includes a message type, the MAC address of the communication apparatus, the MAC address of the partner communication apparatus, and the communication bandwidth used in communication. The efficiency promotion request message shown in FIG. 10 sets “communication path efficiency promotion request” in the message type, “0x0001aabbccdd” in the MAC address of the communication apparatus (STA1) 10, “0x0002bbccddee” in the MAC address of the partner communication apparatus (STA2) 10, and “10 Mbps” in the communication bandwidth.

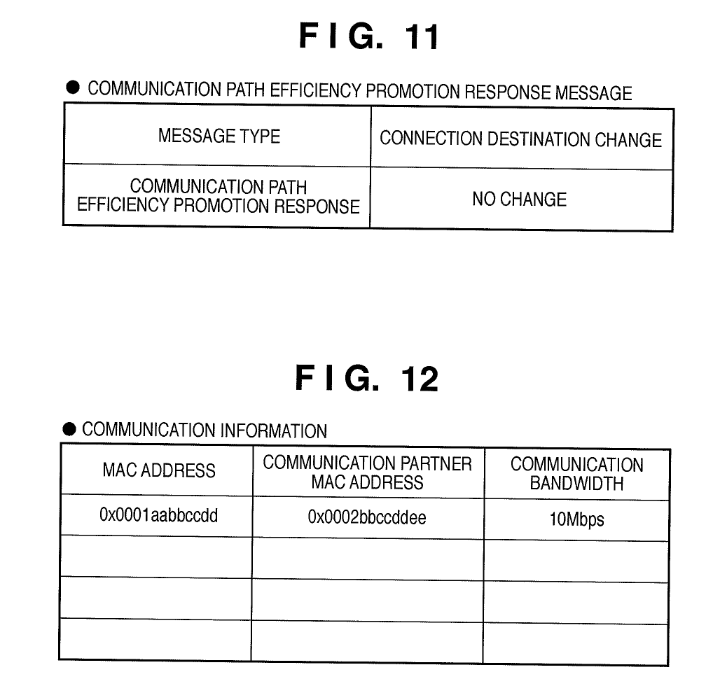

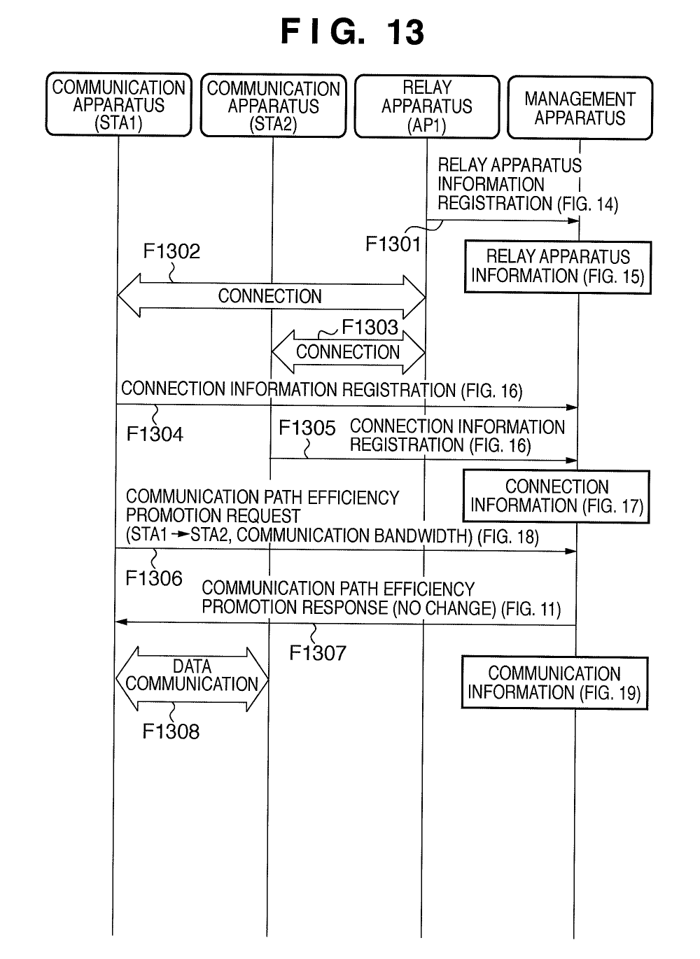

Upon receiving the efficiency promotion request message, the management apparatus 30 executes communication path determination processing, and then transmits a communication path efficiency promotion response message (to be also abbreviated as an efficiency promotion response message hereinafter) to the communication apparatus (STA1) 10 of the efficiency promotion request message transmission source (F507). FIG. 11 shows an example of the data structure of the efficiency promotion response message. The efficiency promotion response message includes a message type and the presence/absence of change of the connection destination relay apparatus. The efficiency promotion response message shown in FIG. 11 sets “communication path efficiency promotion response” in the message type, and “no connection destination change” in the presence/absence of change of the connection destination relay apparatus.

The outline of the communication path determination processing will briefly be described. As is apparent from the connection information described with reference to FIG. 9, only one relay apparatus exists on the communication path between the communication apparatuses (STA1 and STA2). Additionally, only one frequency channel is used between the two communication apparatuses. As for the communication bandwidth, the uplink and downlink of the communication bandwidth (10 Mbps) of the communication apparatus 10 fall within the range of the maximum bandwidth (20 Mbps) of the relay apparatus 20, as is apparent from the relay apparatus information and the efficiency promotion request message described with reference to FIGS. 7 and 10. Hence, in this case, the communication path does not change, and “no change” is set in the connection destination change of the efficiency promotion response message.

Upon receiving the communication path efficiency promotion response, the communication apparatus (STA1) 10 recognizes that the connection destination relay apparatus does not change, and then starts data communication with the communication apparatus (STA2) 10 (F508).

After transmitting the efficiency promotion response message, the management apparatus 30 updates communication information managed by the communication information management unit 37. FIG. 12 shows an example of the communication information. As shown in FIG. 12, the communication information includes the MAC address of the communication apparatus, the MAC address of the partner communication apparatus, and the communication bandwidth to be used.

FIG. 13 shows the sequence of processing of causing the communication apparatus (STA1) 10 to communicate with the communication apparatus (STA2) 10 via the relay apparatus (AP1) 20. An example will be explained in which the communication path does not change.

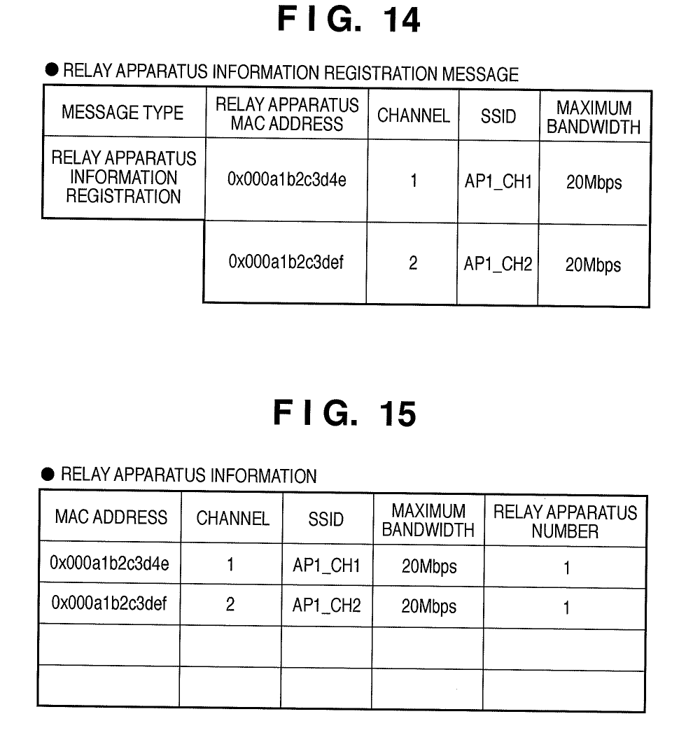

When the processing starts, the relay apparatus (AP1) 20 registers relay apparatus information in the management apparatus 30. In the relay apparatus information registration processing, the relay apparatus 20 sends a relay apparatus information registration message to the management apparatus 30 (F1301). FIG. 14 shows an example of the data structure of the relay apparatus information registration message. FIG. 14 shows a relay apparatus information registration message of the relay apparatus 20 having a plurality of frequency channels. The relay apparatus information registration message shown in FIG. 14 sets “0x000a1b2c3d4e” in the MAC address of the relay apparatus, “1” in the frequency channel, “AP1_CH1” in the SSID, and “20 Mbps” in the maximum bandwidth. The message also sets, for another frequency channel, “0x000a1b2c3def” in the MAC address of the relay apparatus, “2” in the frequency channel, “AP1_CH2” in the SSID, and “20 Mbps” in the maximum bandwidth.

Upon receiving the relay apparatus information registration message, the management apparatus 30 updates, based on the message, relay apparatus information managed by the relay apparatus information management unit 35. FIG. 15 shows an example of relay apparatus information updated based on the relay apparatus information registration message shown in FIG. 14. In the relay apparatus information shown in FIG. 15, since the relay apparatus (AP1) 20 has two frequency channels, the same relay apparatus number is assigned to associate the two pieces of information.

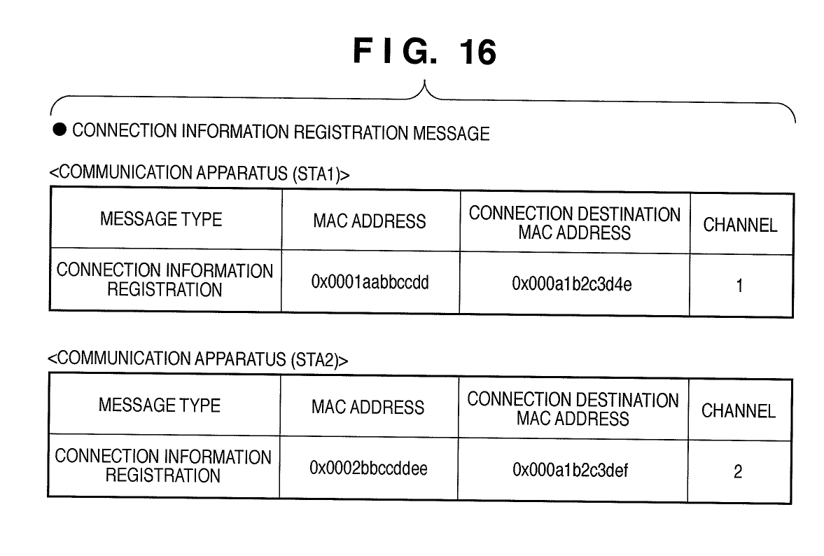

The communication apparatuses (STA1 and STA2) are connected to the relay apparatus (AP1) 20 (F1302 and F1303). When connection to the relay apparatus 20 is done, each of the communication apparatuses (STA1 and STA2) registers connection information in the management apparatus 30 (F1304 and F1305). In the connection information registration processing, each communication apparatus 10 sends a connection information registration message to the management apparatus 30. FIG. 16 shows an example of the data structure of the connection information registration message. FIG. 16 shows the connection information registration messages of the communication apparatuses (STA1 and STA2). More specifically, as the connection information of the communication apparatus (STA1) 10, the message sets “0x0001aabbccdd” in the MAC address of the communication apparatus, “0x000a1b2c3d4e” in the MAC address of the connection destination relay apparatus, and “1” in the frequency channel. As the connection information of the communication apparatus (STA2) 10, the message sets “0x0002bbccddee” in the MAC address of the communication apparatus, “0x000a1b2c3def” in the MAC address of the connection destination relay apparatus, and “2” in the frequency channel.

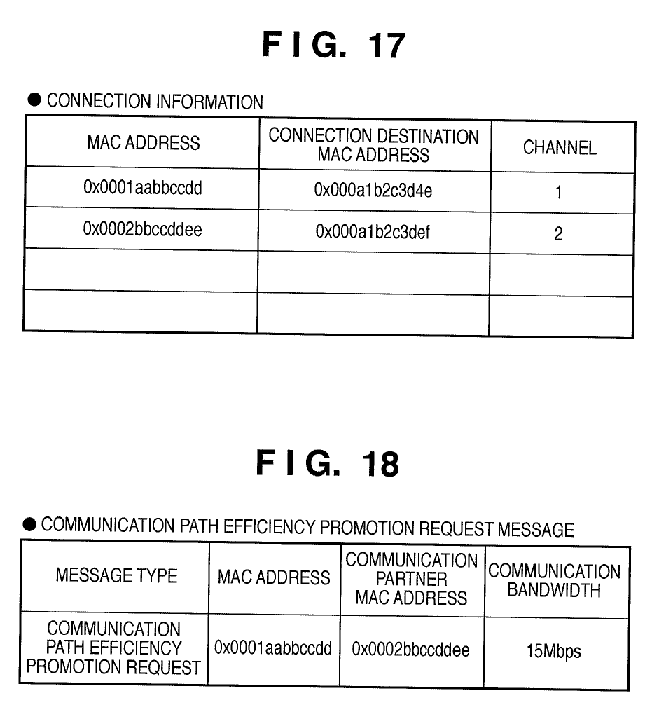

Upon receiving the connection information registration messages, the management apparatus 30 updates, based on the messages, connection information managed by the connection information management unit 36. FIG. 17 shows an example of connection information updated based on the connection information registration messages shown in FIG. 16. As described above, connection information includes the MAC address of the communication apparatus, the MAC address of the connection destination relay apparatus, and the frequency channel used in wireless communication of the relay apparatus.

The communication apparatus (STA1) 10 transmits an efficiency promotion request message to the management apparatus 30 prior to the start of data communication with the communication apparatus (STA2) 10 (F1306). FIG. 18 shows an example of the data structure of the efficiency promotion request message. The efficiency promotion request message shown in FIG. 18, that is, the efficiency promotion request message from the communication apparatus (STA1) 10 sets “0x0001aabbccdd” in the MAC address of the communication apparatus (STA1) 10, “0x0002bbccddee” in the MAC address of the partner communication apparatus (STA2) 10, and “15 Mbps” in the communication bandwidth.

Upon receiving the efficiency promotion request message, the management apparatus 30 executes communication path determination processing, and then transmits an efficiency promotion response message to the communication apparatus (STA1) 10 of the efficiency promotion request message transmission source (F1307). The efficiency promotion response message transmitted here has the same contents as in FIG. 11 and sets “no connection destination change”.

The outline of the communication path determination processing will briefly be described. As is apparent from the relay apparatus information described with reference to FIG. 15 and the connection information described with reference to FIG. 17, only one relay apparatus exists on the communication path between the communication apparatuses (STA1 and STA2). Additionally, two frequency channels, that is, channel 1 and channel 2 are used between the two communication apparatuses. More specifically, the communication apparatus (STA1) 10 communicates with the relay apparatus 20 via channel 1. The communication apparatus (STA2) 10 communicates with the relay apparatus 20 via channel 2. As for the communication bandwidth, each of the communication bandwidths of channels 1 and 2 falls within the range of the maximum bandwidth (20 Mbps) of the relay apparatus 20, as is apparent from the relay apparatus information described with reference to FIG. 15 and the efficiency promotion request message described with reference to FIG. 18. Hence, in this case, the communication path does not change, and “no change” is set in the connection destination change of the efficiency promotion response message.

Upon receiving the communication path efficiency promotion response, the communication apparatus (STA1) 10 recognizes that the connection destination relay apparatus does not change, and then starts data communication with the communication apparatus (STA2) 10 (F1308).

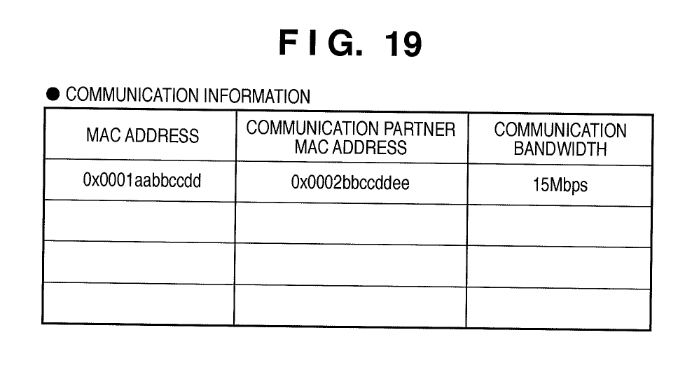

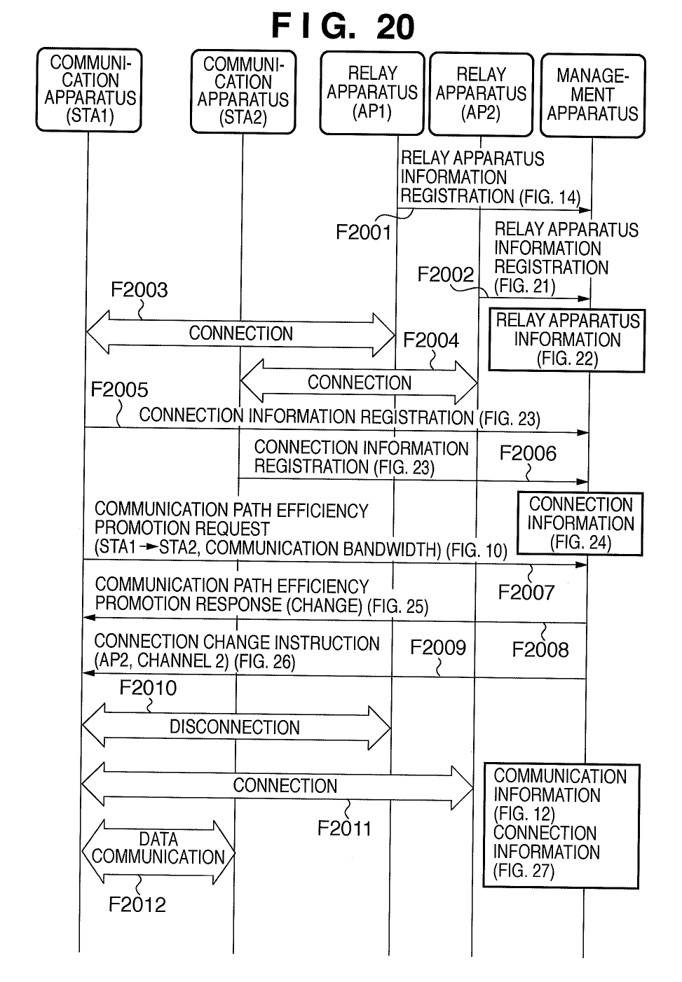

After transmitting the efficiency promotion response message, the management apparatus 30 updates communication information managed by the communication information management unit 37. FIG. 19 shows an example of the communication information. As described above, the communication information includes the MAC address of the communication apparatus, the MAC address of the partner communication apparatus, and the communication bandwidth to be used.

FIG. 20 shows the sequence of processing of causing the communication apparatus (STA1) 10 to communicate with the communication apparatus (STA2) 10 via the relay apparatus (AP2) 20. An example will be explained in which the communication path changes.

When the processing starts, the relay apparatus (AP1) 20 registers relay apparatus information in the management apparatus 30. In the relay apparatus information registration processing, the relay apparatus 20 sends a relay apparatus information registration message to the management apparatus 30 (F2001). The relay apparatus information registration message in the process of F2001 has the same contents as in FIG. 14.

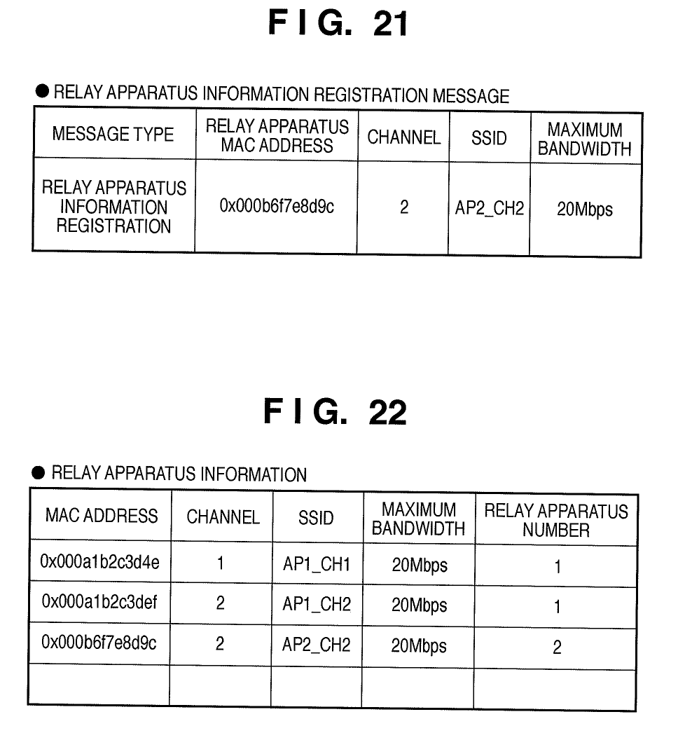

The relay apparatus (AP2) 20 also performs relay apparatus information registration processing (F2002). FIG. 21 shows an example of the data structure of the relay apparatus information registration message in the process of F2002. The relay apparatus information registration message shown in FIG. 21 sets “0x000b6f7e8d9c” in the MAC address of the relay apparatus, “2” in the frequency channel, “AP2_CH2” in the SSID, and “20 Mbps” in the maximum bandwidth.

Upon receiving the relay apparatus information registration messages, the management apparatus 30 updates, based on the messages sent from the relay apparatuses (AP1 and AP2), relay apparatus information managed by the relay apparatus information management unit 35. FIG. 22 shows an example of relay apparatus information updated based on the relay apparatus information registration messages shown in FIGS. 14 and 21. In the relay apparatus information shown in FIG. 22, since the relay apparatus (AP1) 20 has two frequency channels, the same relay apparatus number is assigned to associate the channels of the relay apparatus.

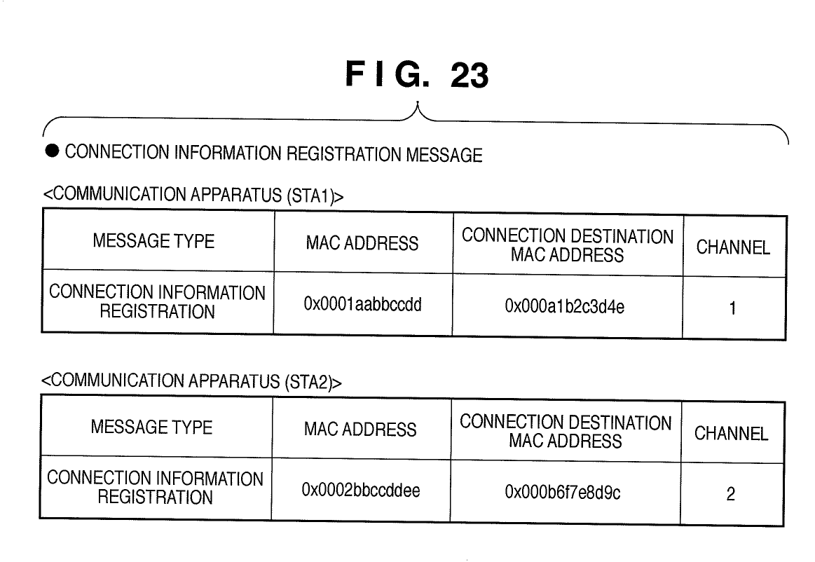

The communication apparatus (STA1) 10 is connected to the relay apparatus (AP1) 20 (F2003). The communication apparatus (STA2) 10 is connected to the relay apparatus (AP2) 20 (F2004). When connection to the relay apparatuses 20 is done, each of the communication apparatuses (STA1 and STA2) registers connection information in the management apparatus 30 (F2005 and F2006). In the connection information registration processing, each communication apparatus 10 sends a connection information registration message to the management apparatus 30. FIG. 23 shows an example of the data structure of the connection information registration message. FIG. 23 shows the connection information registration messages of the communication apparatuses (STA1 and STA2). More specifically, as the connection information of the communication apparatus (STA1) 10, the message sets “0x0001aabbccdd” in the MAC address of the communication apparatus, “0x000a1b2c3d4e” in the MAC address of the connection destination relay apparatus, and “1” in the frequency channel. As the connection information of the communication apparatus (STA2) 10, the message sets “0x0002bbccddee” in the MAC address of the communication apparatus, “0x000b6f7e8d9c” in the MAC address of the connection destination relay apparatus, and “2” in the frequency channel.

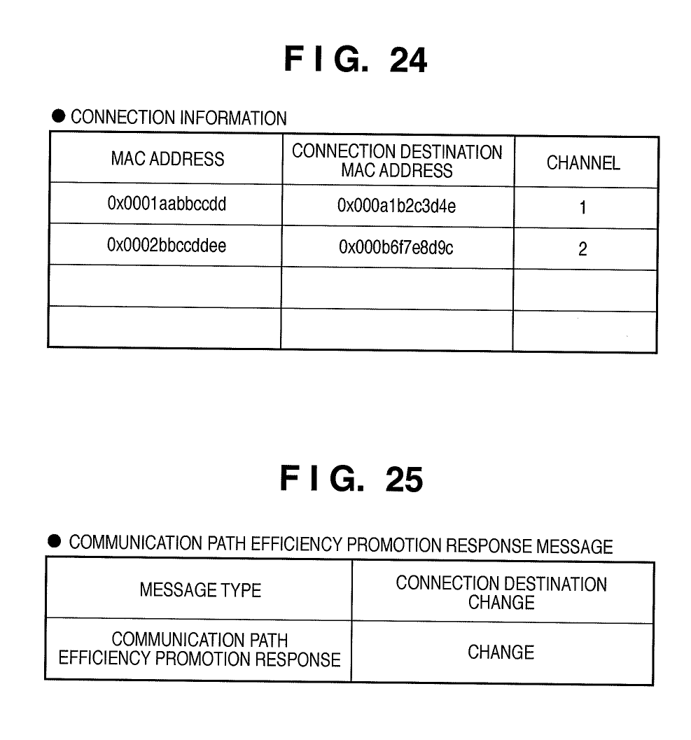

Upon receiving the connection information registration messages, the management apparatus 30 updates, based on the messages, connection information managed by the connection information management unit 36. FIG. 24 shows an example of connection information updated based on the connection information registration messages shown in FIG. 23. As described above, connection information includes the MAC address of the communication apparatus, the MAC address of the connection destination relay apparatus, and the frequency channel used in wireless communication of the relay apparatus.

The communication apparatus (STA1) 10 transmits an efficiency promotion request message to the management apparatus 30 prior to the start of data communication with the communication apparatus (STA2) 10 (F2007). The efficiency promotion request message in the process of F2007 has the same contents as in FIG. 10.

Upon receiving the efficiency promotion request message, the management apparatus 30 executes communication path determination processing, and then transmits an efficiency promotion response message to the communication apparatus (STA1) 10 of the efficiency promotion request message transmission source (F2008). FIG. 25 shows an example of the data structure of the efficiency promotion response message. The efficiency promotion response message shown in FIG. 25 sets “connection destination change”.

The outline of the communication path determination processing will briefly be described. As is apparent from the relay apparatus information described with reference to FIG. 22 and the connection information described with reference to FIG. 24, two relay apparatuses exist on the communication path between the communication apparatuses (STA1 and STA2). Additionally, two frequency channels, that is, channel 1 and channel 2 are used between the two communication apparatuses. The communication path is changed to use one relay apparatus between the communication apparatuses (STA1 and STA2). As for the communication bandwidth, the communication bandwidth between the apparatuses falls within the range of the maximum bandwidth of the relay apparatus 20 regardless of the connection destination which is one of the relay apparatuses (AP1 and AP2), as is apparent from the relay apparatus information described with reference to FIG. 22 and the efficiency promotion request message described with reference to FIG. 10. Hence, the relay apparatus (AP2) 20 having a smaller number of channels is selected as the transit point so that the connection destination relay apparatus of the communication apparatus (STA1) 10 of the efficiency promotion request message transmission source changes. For this reason, “change” is set in the connection destination change of the efficiency promotion response message. A relay apparatus having a smaller number of channels is preferentially selected as a transit point because a relay apparatus having a larger number of channels may probably switch the channel more frequently than the relay apparatus having a smaller number of channels. Channel switching often applies a heavy load to the processing of the relay apparatus, resulting in a decrease in the transmission speed.

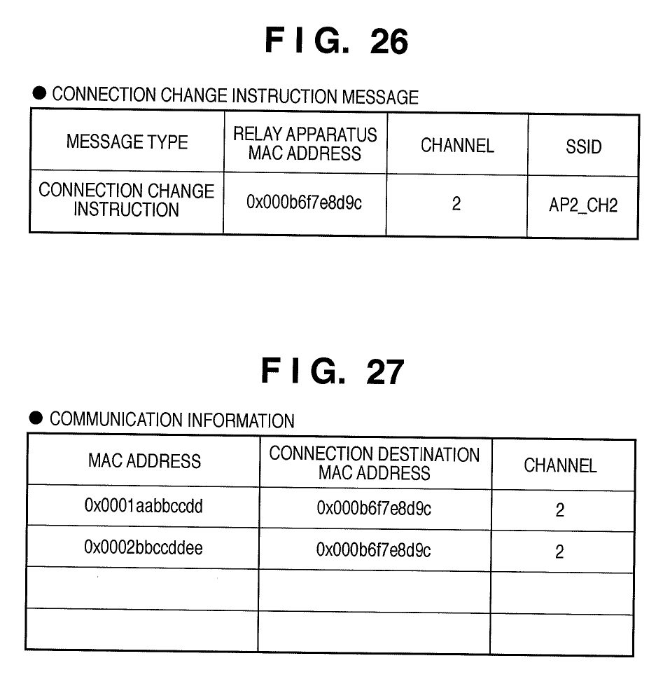

Upon receiving the communication path efficiency promotion response, the communication apparatus (STA1) 10 recognizes that the connection destination relay apparatus changes, and receives a connection change instruction message from the management apparatus 30 (F2009). FIG. 26 shows an example of the data structure of the connection change instruction message. The connection change instruction message includes a message type, the MAC address of the relay apparatus, and the frequency channel and SSID used in wireless communication of the relay apparatus. The connection change instruction message shown in FIG. 26 sets “connection change instruction” in the message type, “0x000b6f7e8d9c” in the MAC address of the relay apparatus, “2” in the frequency channel, and “AP2_CH2” in the SSID.

Upon receiving the connection change instruction message, the communication apparatus (STA1) 10 is disconnected from the relay apparatus (AP1) 20 (F2010) and connected to the relay apparatus (AP2) 20 (F2011). The communication apparatus (STA1) 10 then starts data communication with the communication apparatus (STA2) 10 (F2012).

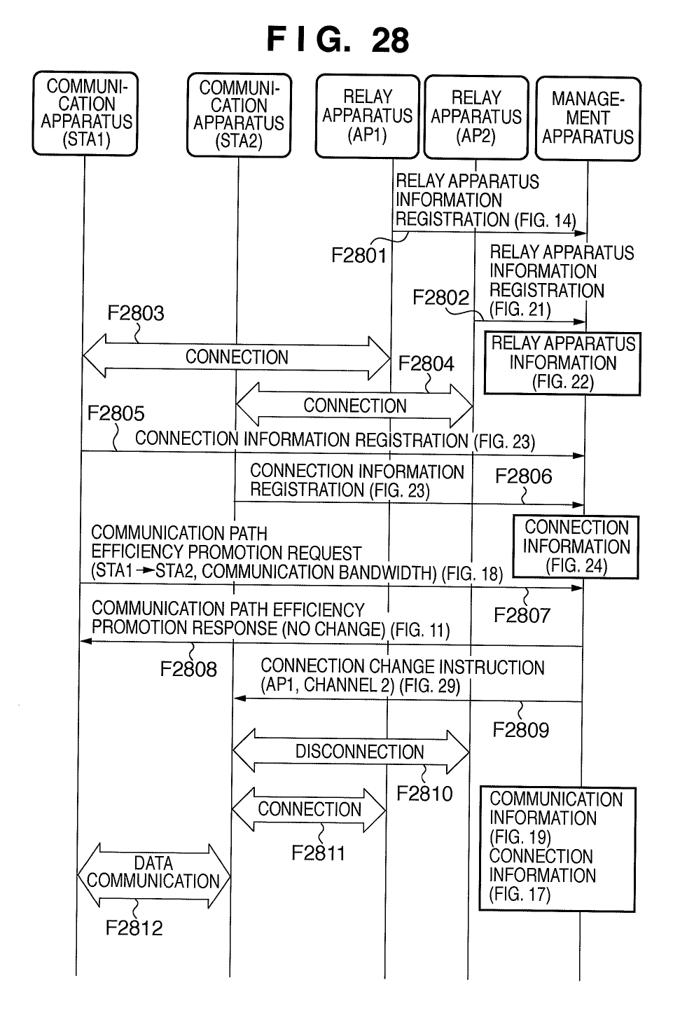

After transmitting the efficiency promotion response message, the management apparatus 30 updates communication information managed by the communication information management unit 37. The communication information has the same contents as in FIG. 12. FIG. 27 shows an example of connection information managed by the connection information management unit 36 of the management apparatus 30 after the above-described communication path change. In the communication information shown in FIG. 27, the MAC address of the connection destination relay apparatus has changed from that in the communication information shown in FIG. 24 before the communication path change. More specifically, the connection destination of the communication apparatus (STA1) 10 has changed from the relay apparatus (AP1) 20 to the relay apparatus (AP2) 20.

FIG. 28 shows the sequence of processing of causing the communication apparatus (STA1) 10 to communicate with the communication apparatus (STA2) 10 via the relay apparatuses (AP1 and AP2). An example will be explained in which the communication path changes.

When the processing starts, the relay apparatus (AP1) 20 registers relay apparatus information in the management apparatus 30. In the relay apparatus information registration processing, the relay apparatus 20 sends a relay apparatus information registration message to the management apparatus 30 (F2801). The relay apparatus information registration message in the process of F2801 has the same contents as in FIG. 14.

The relay apparatus (AP2) 20 also performs relay apparatus information registration processing (F2802). The relay apparatus information registration message in the process of F2802 has the same contents as in FIG. 21.

Upon receiving the relay apparatus information registration messages, the management apparatus 30 updates, based on the messages sent from the relay apparatuses (AP1 and AP2), relay apparatus information managed by the relay apparatus information management unit 35. The relay apparatus information has the same contents as in FIG. 22.

The communication apparatus (STA1) 10 is connected to the relay apparatus (AP1) 20 (F2803). The communication apparatus (STA2) 10 is connected to the relay apparatus (AP2) 20 (F2804). When connection to the relay apparatuses 20 is done, each of the communication apparatuses (STA1 and STA2) registers connection information in the management apparatus 30 (F2805 and F2806). In the connection information registration processing, each communication apparatus 10 sends a connection information registration message to the management apparatus 30. The connection information registration message has the same contents as in FIG. 23. Upon receiving the connection information registration messages, the management apparatus 30 updates, based on the messages, connection information managed by the connection information management unit 36. The connection information has the same contents as in FIG. 24.

The communication apparatus (STA1) 10 transmits an efficiency promotion request message to the management apparatus 30 prior to the start of data communication with the communication apparatus (STA2) 10 (F2807). The efficiency promotion request message in the process of F2807 has the same contents as in FIG. 18.

Upon receiving the efficiency promotion request message, the management apparatus 30 executes communication path determination processing, and then transmits an efficiency promotion response message to the communication apparatus (STA1) 10 of the efficiency promotion request message transmission source (F2808). The efficiency promotion response message transmitted here has the same contents as in FIG. 11 and sets “no connection destination change”.

The outline of the communication path determination processing will briefly be described. As is apparent from the relay apparatus information described with reference to FIG. 22 and the connection information described with reference to FIG. 24, two relay apparatuses exist on the communication path between the communication apparatuses (STA1 and STA2). Additionally, two frequency channels, that is, channel 1 and channel 2 are used between the two communication apparatuses. The communication path is changed to use one relay apparatus between the communication apparatuses (STA1 and STA2). As for the communication bandwidth, when the relay apparatus (AP2) 20 is selected as the connection destination, the communication bandwidth between the apparatuses exceeds the maximum bandwidth of the relay apparatus 20, as is apparent from the relay apparatus information described with reference to FIG. 22 and the efficiency promotion request message described with reference to FIG. 18. Hence, the relay apparatus (AP1) 20 is selected as the transit point so the connection destination relay apparatus of the communication apparatus (STA1) 10 of the efficiency promotion request message transmission source does not change. For this reason, “no change” is set in the connection destination change of the efficiency promotion response message.

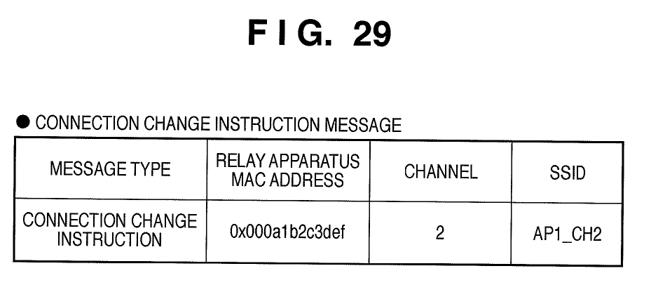

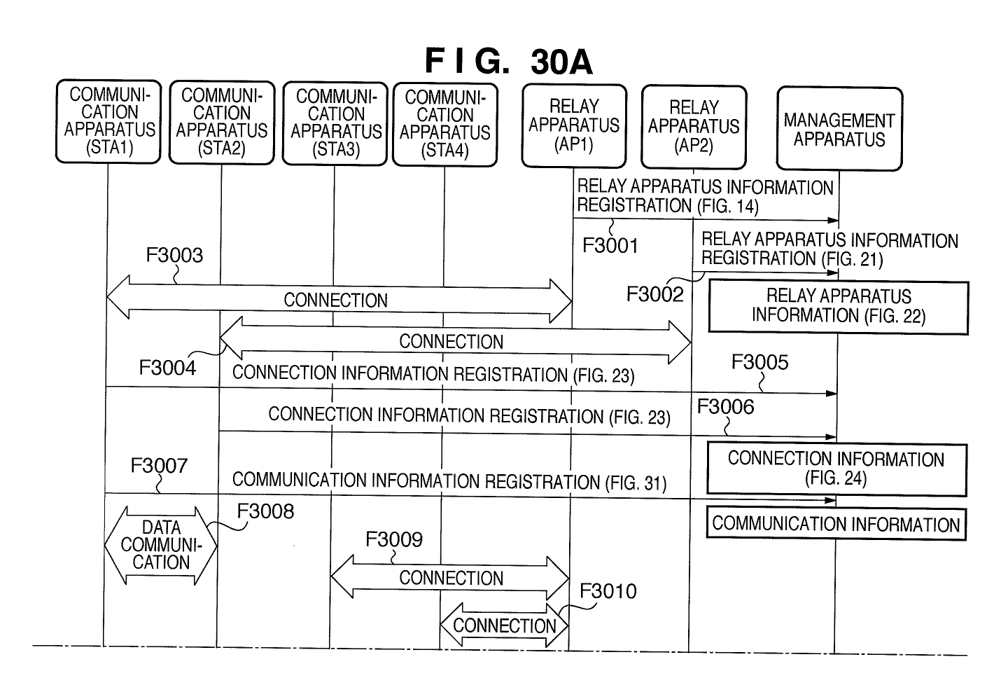

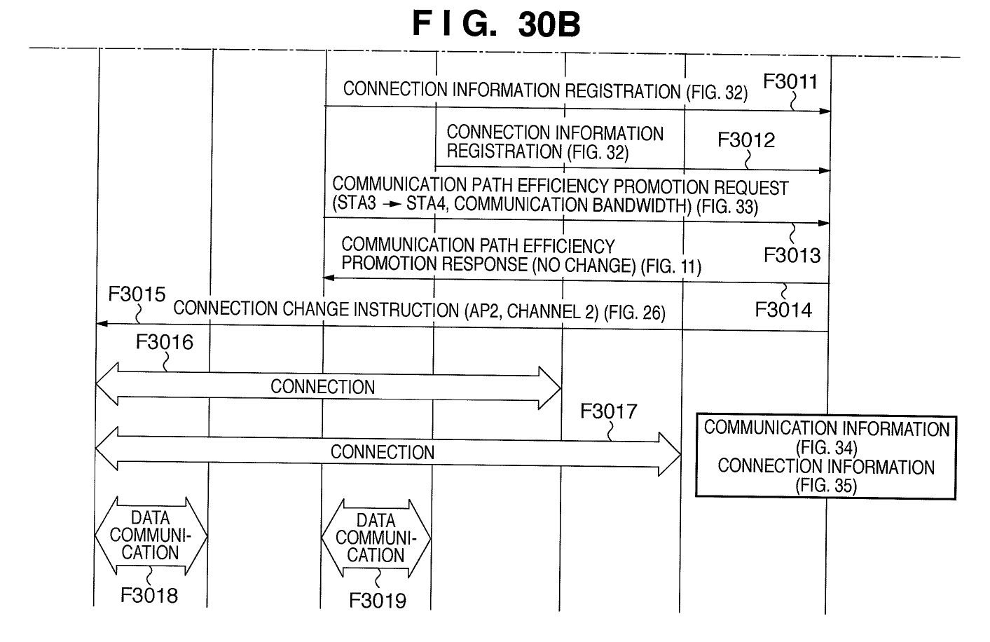

As the result of the above-described communication path determination processing, the communication path is changed to connect the communication apparatus (STA2) 10 to the relay apparatus (AP1) 20. The management apparatus 30 transmits a connection change instruction message to the communication apparatus (STA2) 10 (F2809). FIG. 29 shows an example of the data structure of the connection change instruction message. The connection change instruction message shown in FIG. 29 sets “connection change instruction” in the message type, “0x000a1b2c3def” in the MAC address of the relay apparatus, “2” in the frequency channel, and “AP1_CH2” in the SSID.

Upon receiving the connection change instruction message, the communication apparatus (STA2) 10 is disconnected from the relay apparatus (AP2) 20 (F2810) and connected to the relay apparatus (AP1) 20 (F2811). The communication apparatus (STA2) 10 then starts data communication with the communication apparatus (STA1) 10 (F2812).

After transmitting the efficiency promotion response message, the management apparatus 30 updates communication information managed by the communication information management unit 37. The communication information has the same contents as in FIG. 19. Connection information managed by the connection information management unit 36 of the management apparatus 30 after the above-described communication path change is the same as in FIG. 17.

FIGS. 30A and 30B show the sequence of processing of causing the communication apparatuses (STA1 and STA2) to communicate with each other via the relay apparatuses (AP1 and AP2). In FIGS. 30A and 30B, the communication apparatuses (STA3 and STA4) are also connected to the relay apparatus (AP1) to communicate with each other. An example will be explained in which the communication path changes.

When the processing starts, the relay apparatus (AP1) 20 registers relay apparatus information in the management apparatus 30. In the relay apparatus information registration processing, the relay apparatus 20 sends a relay apparatus information registration message to the management apparatus 30 (F3001). The relay apparatus information registration message in the process of F3001 has the same contents as in FIG. 14.

The relay apparatus (AP2) 20 also performs relay apparatus information registration processing (F3002). The relay apparatus information registration message in the process of F3002 has the same contents as in FIG. 21.

Upon receiving the relay apparatus information registration messages, the management apparatus 30 updates, based on the messages sent from the relay apparatuses (AP1 and AP2), relay apparatus information managed by the relay apparatus information management unit 35. The relay apparatus information has the same contents as in FIG. 22.

The communication apparatus (STA1) 10 is connected to the relay apparatus (AP1) 20 (F3003). The communication apparatus (STA2) 10 is connected to the relay apparatus (AP2) 20 (F3004). When connection to the relay apparatuses 20 is done, each of the communication apparatuses (STA1 and STA2) registers connection information in the management apparatus 30 (F3005 and F3006). In the connection information registration processing, each communication apparatus 10 sends a connection information registration message to the management apparatus 30. The connection information registration message has the same contents as in FIG. 23. Upon receiving the connection information registration messages, the management apparatus 30 updates, based on the messages, connection information managed by the connection information management unit 36. The connection information has the same contents as in FIG. 24.

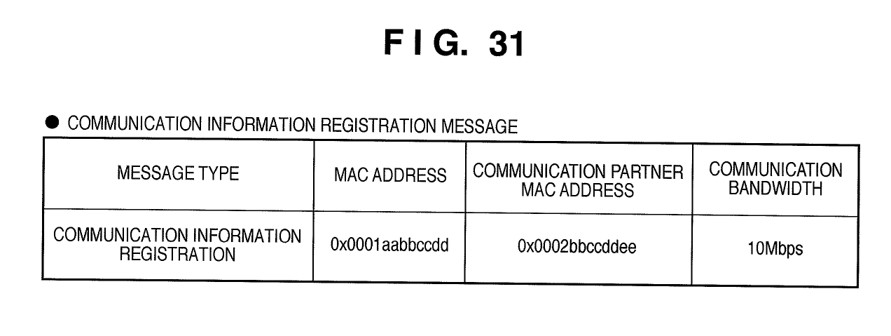

After transmitting the connection information registration message, the communication apparatus (STA1) 10 transmits not a communication path efficiency promotion request but a communication information registration message to the management apparatus 30 prior to the start of data communication with the communication apparatus (STA2) 10 (F3007). FIG. 31 shows an example of the data structure of the communication information registration message. The communication information registration message includes a message type, the MAC address of the communication apparatus, the MAC address of the partner communication apparatus, and the communication bandwidth used in communication. The communication information registration message shown in FIG. 31 sets “communication information registration” in the message type, “0x0001aabbccdd” in the MAC address of the communication apparatus (STA1) 10, “0x0002bbccddee” in the MAC address of the partner communication apparatus (STA2) 10, and “10 Mbps” in the communication bandwidth.

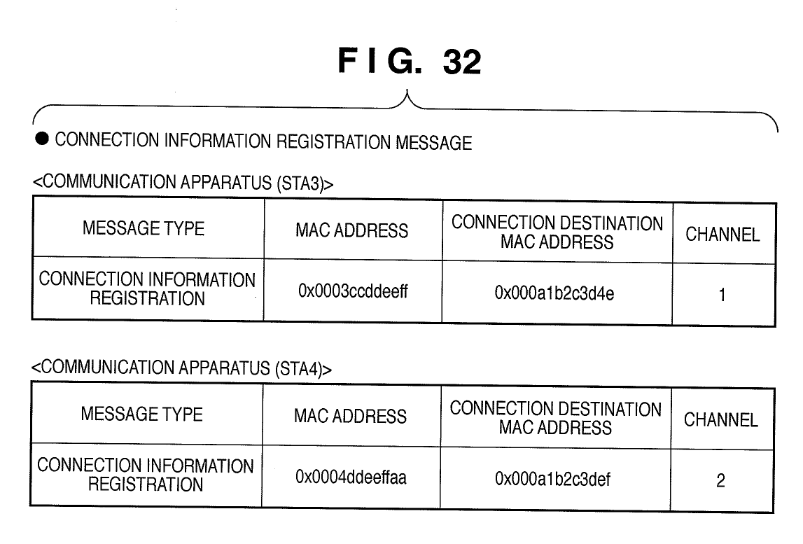

After communication information registration, the communication apparatus (STA1) 10 starts data communication with the communication apparatus (STA2) 10 (F3008). Then, the communication apparatuses (STA3 and STA4) are also connected to the relay apparatus (AP1) 20 (F3009 and F3010). When connection to the relay apparatus 20 is done, each of the communication apparatuses (STA3 and STA4) registers connection information in the management apparatus 30 (F3011 and F3012). In the connection information registration processing, each communication apparatus 10 sends a connection information registration message to the management apparatus 30. FIG. 32 shows an example of the data structure of the connection information registration message. FIG. 32 shows the connection information registration messages of the communication apparatuses (STA3 and STA4). More specifically, as the connection information of the communication apparatus (STA3) 10, the message sets “0x0003ccddeeff” in the MAC address of the communication apparatus, “0x000a1b2c3d4e” in the MAC address of the connection destination relay apparatus, and “1” in the frequency channel. As the connection information of the communication apparatus (STA4) 10, the message sets “0x0004ddeeffaa” in the MAC address of the communication apparatus, “0x000a1b2c3def” in the MAC address of the connection destination relay apparatus, and “2” in the frequency channel.

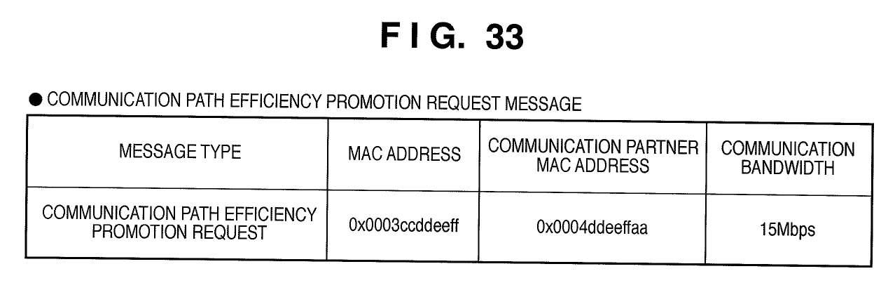

The communication apparatus (STA3) 10 transmits an efficiency promotion request message to the management apparatus 30 prior to the start of data communication with the communication apparatus (STA4) 10 (F3013). FIG. 33 shows an example of the data structure of the efficiency promotion request message in the process of F3013. The efficiency promotion request message shown in FIG. 33 sets “0x0003ccddeeff” in the MAC address of the communication apparatus (STA3) 10, “0x0004ddeeffaa” in the MAC address of the partner communication apparatus (STA4) 10, and “15 Mbps” in the communication bandwidth.

Upon receiving the efficiency promotion request message, the management apparatus 30 executes communication path determination processing, and then transmits an efficiency promotion response message to the communication apparatus (STA3) 10 of the efficiency promotion request message transmission source (F3014). The efficiency promotion response message transmitted here has the same contents as in FIG. 11 and sets “no connection destination change”.

The outline of the communication path determination processing will briefly be described. As is apparent from the relay apparatus information described with reference to FIG. 22 and the connection information registration message described with reference to FIG. 32, only one relay apparatus exists on the communication path between the communication apparatuses (STA3 and STA4). Hence, the communication path change determination is done for the other communication apparatuses 10 connected to the relay apparatus (AP1) 20. In this case, as is apparent from the relay apparatus information described with reference to FIG. 22 and the connection information described with reference to FIG. 24, two relay apparatuses exist on the communication path between the communication apparatuses (STA1 and STA2). Additionally, two frequency channels, that is, channel 1 and channel 2 are used between the two communication apparatuses. The communication path is changed to use one relay apparatus on the communication path between the communication apparatuses (STA1 and STA2) and also use one frequency channel for the communication. As for the communication bandwidth, the communication bandwidth between the apparatuses falls within the range of the maximum bandwidth of the relay apparatus 20 regardless of the connection destination which is one of the relay apparatuses (AP1 and AP2), as is apparent from the relay apparatus information described with reference to FIG. 22 and the communication information registration message described with reference to FIG. 31. Hence, the relay apparatus (AP2) 20 having a smaller number of channels is selected as the transit point so the connection destination relay apparatus of the communication apparatus (STA3) 10 of the efficiency promotion request message transmission source does not change. For this reason, “no change” is set in the connection destination change of the efficiency promotion response message. A relay apparatus having a smaller number of channels is preferentially selected as a transit point in order to avoid a decrease in the transmission speed caused by channel switching, as described above.

As the result of the communication path determination processing, the communication path is changed to connect the communication apparatus (STA1) 10 to the relay apparatus (AP2) 20. The management apparatus 30 transmits a connection change instruction message to the communication apparatus (STA1) 10 (F3015). The connection change instruction message has the same contents as in FIG. 26.

Upon receiving the connection change instruction message, the communication apparatus (STA1) 10 is disconnected from the relay apparatus (AP1) 20 (F3016) and connected to the relay apparatus (AP2) 20 (F3017). The communication apparatus (STA1) 10 then resumes data communication with the communication apparatus (STA2) 10 (F3018). Data communication between the communication apparatus (STA3) 10 and the communication apparatus (STA4) 10 starts via the relay apparatus (AP1) 20 (F3019).

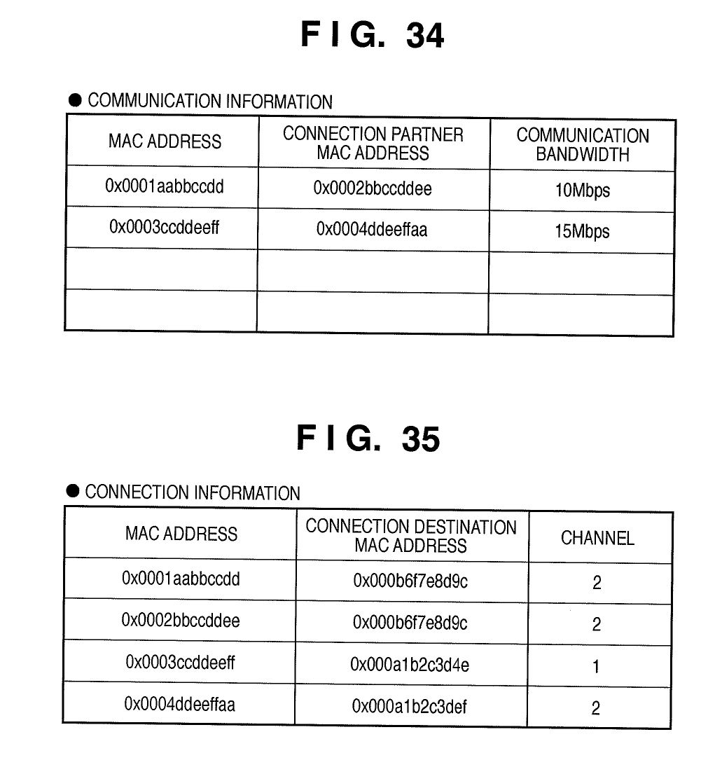

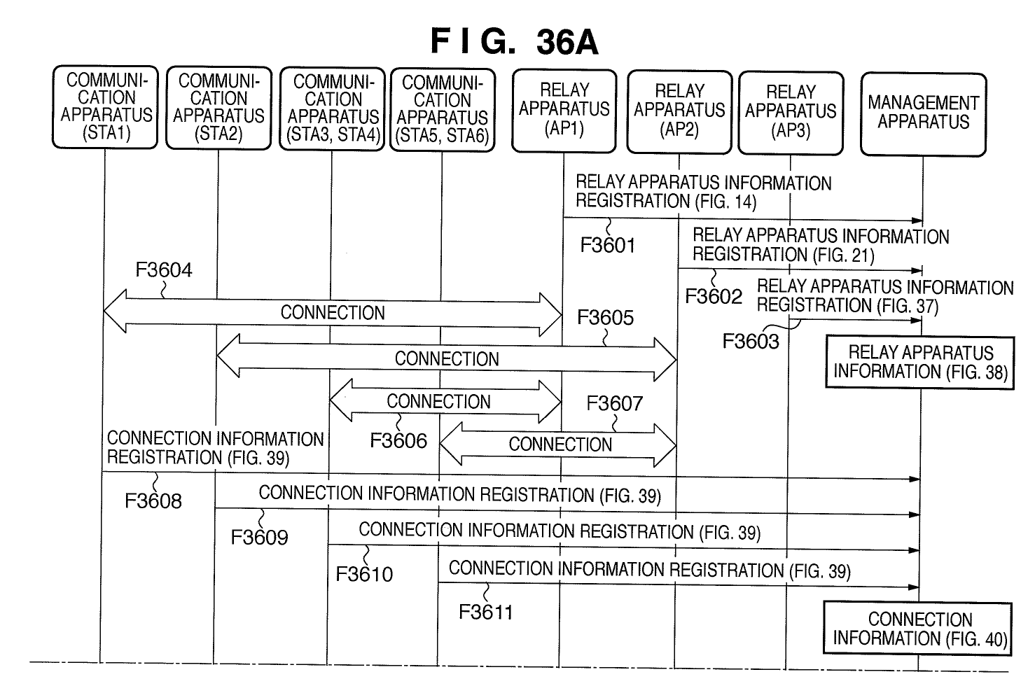

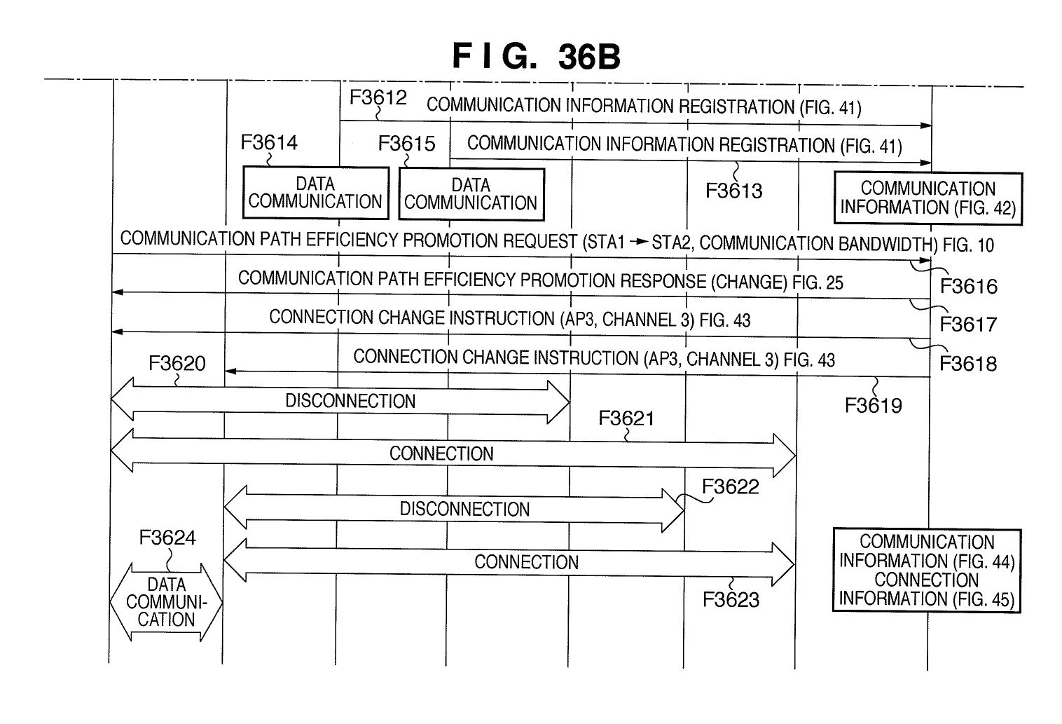

After transmitting the efficiency promotion response message, the management apparatus 30 updates communication information managed by the communication information management unit 37. FIG. 34 shows an example of the communication information. As described above, the communication information includes the MAC address of the communication apparatus, the MAC address of the partner communication apparatus, and the communication bandwidth to be used. FIG. 35 shows an example of connection information managed by the connection information management unit 36 of the management apparatus 30 after the above-described communication path change. As described above, the connection information includes the MAC address of the communication apparatus, the MAC address of the connection destination relay apparatus, and the frequency channel used in wireless communication of the relay apparatus.

FIGS. 36A and 36B show the sequence of processing of causing the communication apparatuses (STA3 and STA4) to communicate with each other via the relay apparatus (AP1) 20 and causing the communication apparatuses (STA5 and STA6) to communicate with each other via the relay apparatus (AP2) 20. In FIGS. 36A and 36B, the network arrangement includes the relay apparatus (AP3) 20. An example will be explained in which the communication path changes.

When the processing starts, the relay apparatus (AP1) 20 registers relay apparatus information in the management apparatus 30. In the relay apparatus information registration processing, the relay apparatus 20 sends a relay apparatus information registration message to the management apparatus 30 (F3601). The relay apparatus information registration message in the process of F3601 has the same contents as in FIG. 14.

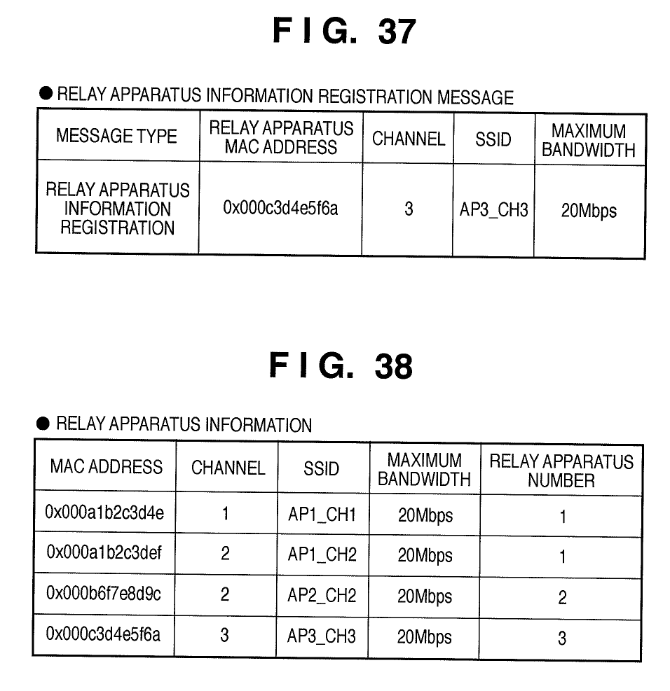

The relay apparatuses (AP2 and AP3) 20 also perform relay apparatus information registration processing (F3602 and F3603). The relay apparatus information registration message in the process of F3602 has the same contents as in FIG. 21. FIG. 37 shows an example of the data structure of the relay apparatus information registration message in the process of F3603. The relay apparatus information registration message shown in FIG. 37 sets “0x000c3d4e5f6a” in the MAC address of the relay apparatus, “3” in the frequency channel, “AP3_CH3” in the SSID, and “20 Mbps” in the maximum bandwidth.

Upon receiving the relay apparatus information registration messages, the management apparatus 30 updates relay apparatus information managed by the relay apparatus information management unit 35. FIG. 38 shows an example of relay apparatus information. As described above, relay apparatus information includes the MAC address of the relay apparatus, the frequency channel and SSID used in wireless communication of the relay apparatus, and the maximum bandwidth allocatable to wireless communication of the relay apparatus. The relay apparatus information also includes a relay apparatus number to associate a plurality of frequency channels of a relay apparatus.

The communication apparatus (STA1) 10 is connected to the relay apparatus (AP1) 20 (F3604). The communication apparatus (STA2) 10 is connected to the relay apparatus (AP2) 20 (F3605). The communication apparatuses (STA3 and STA4) are connected to the relay apparatus (AP1) 20 (F3606). The communication apparatuses (STA5 and STA6) are connected to the relay apparatus (AP2) 20 (F3607).

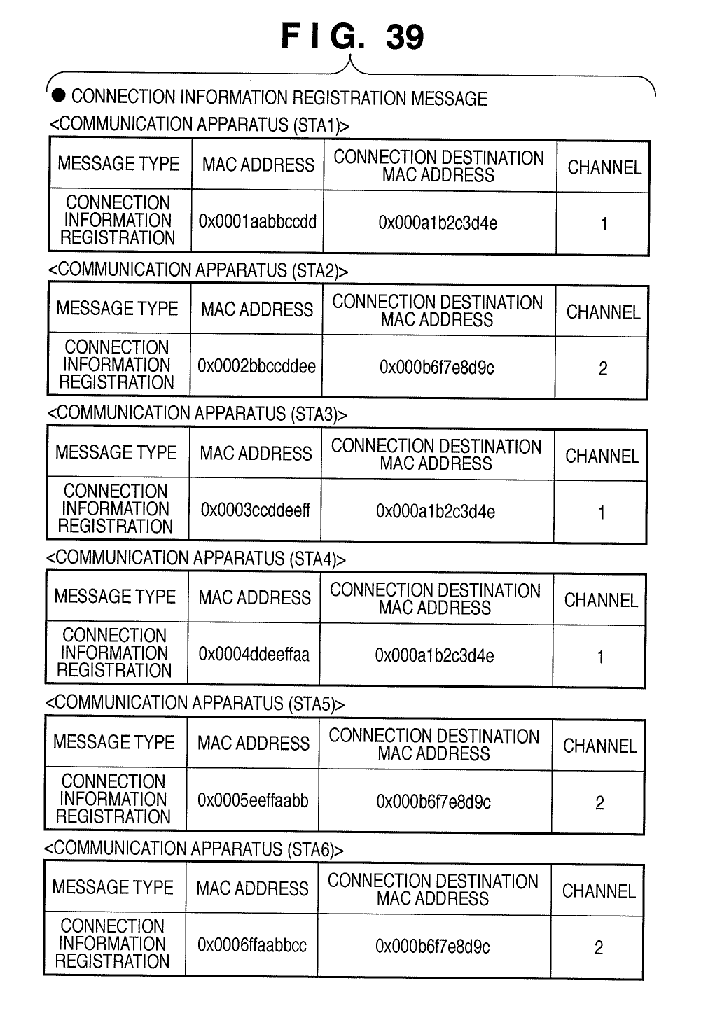

When connection to the relay apparatuses is done, each of the communication apparatuses (STA1 to STA6) registers connection information in the management apparatus 30 (F3608, F3609, F3610, and F3611). In the connection information registration processing, each communication apparatus 10 sends a connection information registration message to the management apparatus 30. FIG. 39 shows an example of the data structure of the connection information registration message in each of the communication apparatuses (STA1 to STA6). Referring to FIG. 39, as the connection information of the communication apparatus (STA1) 10, the message sets “0x0001aabbccdd” in the MAC address of the communication apparatus, “0x000a1b2c3d4e” in the MAC address of the connection destination relay apparatus, and “1” in the frequency channel. As the connection information of the communication apparatus (STA2) 10, the message sets “0x0002bbccddee” in the MAC address of the communication apparatus, “0x000b6f7e8d9c” in the MAC address of the connection destination relay apparatus, and “2” in the frequency channel. As the connection information of the communication apparatus (STA3) 10, the message sets “0x0003ccddeeff” in the MAC address of the communication apparatus, “0x000a1b2c3d4e” in the MAC address of the connection destination relay apparatus, and “1” in the frequency channel. As the connection information of the communication apparatus (STA4) 10, the message sets “0x0004ddeeffaa” in the MAC address of the communication apparatus, “0x000a1b2c3d4e” in the MAC address of the connection destination relay apparatus, and “1” in the frequency channel. As the connection information of the communication apparatus (STA5) 10, the message sets “0x0005eeffaabb” in the MAC address of the communication apparatus, “0x000b6f7e8d9c” in the MAC address of the connection destination relay apparatus, and “2” in the frequency channel. As the connection information of the communication apparatus (STA6) 10, the message sets “0x0006ffaabbcc” in the MAC address of the communication apparatus, “0x000b6f7e8d9c” in the MAC address of the connection destination relay apparatus, and “2” in the frequency channel.

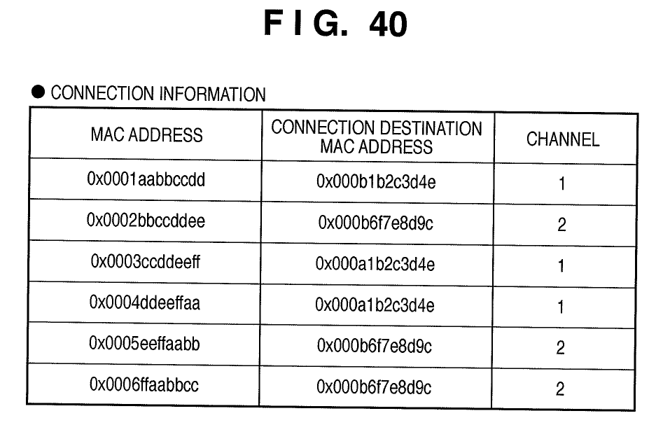

Upon receiving the connection information registration messages, the management apparatus 30 updates, based on the messages, connection information managed by the connection information management unit 36. FIG. 40 shows an example of connection information updated based on the connection information registration messages shown in FIG. 39. As described above, connection information includes the MAC address of the communication apparatus, the MAC address of the connection destination relay apparatus, and the frequency channel used in wireless communication of the relay apparatus.

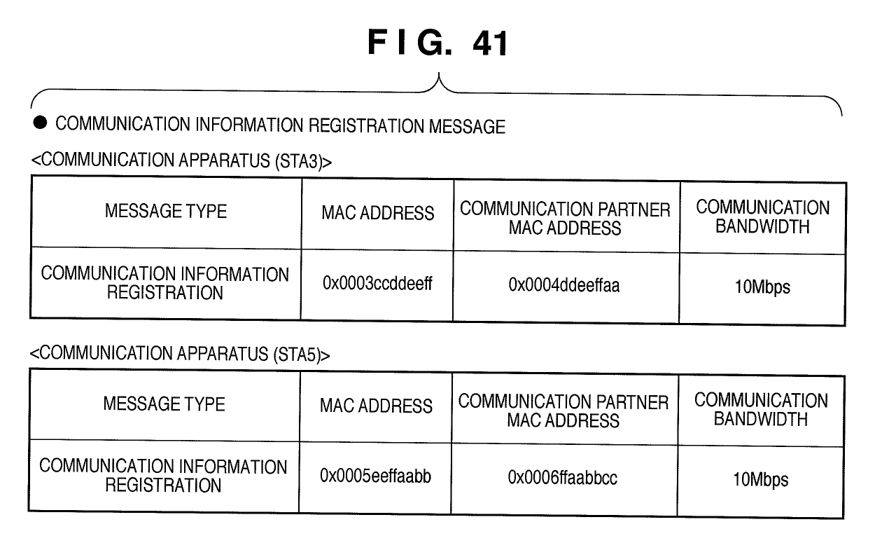

Next, the communication apparatus (STA3) 10 transmits not a communication path efficiency promotion request but a communication information registration message to the management apparatus 30 prior to the start of data communication with the communication apparatus (STA4) 10 (F3612) The communication apparatus (STA5) 10 also transmits not a communication path efficiency promotion request but a communication information registration message to the management apparatus 30 prior to the start of data communication with the communication apparatus (STA6) 10 (F3613). FIG. 41 shows an example of the data structure of the communication information registration messages in the processes of F3612 and F3613. FIG. 41 shows the communication information registration messages of the communication apparatuses (STA3 and STA5). More specifically, the communication information registration message transmitted from the communication apparatus (STA3) 10 sets “0x0003ccddeeff” in the MAC address of the communication apparatus (STA3) 10, “0x0004ddeeffaa” in the MAC address of the partner communication apparatus (STA4) 10, and “10 Mbps” in the communication bandwidth. The communication information registration message transmitted from the communication apparatus (STA5) 10 sets “0x0005eeffaabb” in the MAC address of the communication apparatus (STA5) 10, “0x0006ffaabbcc” in the MAC address of the partner communication apparatus (STA6) 10, and “10 Mbps” in the communication bandwidth.

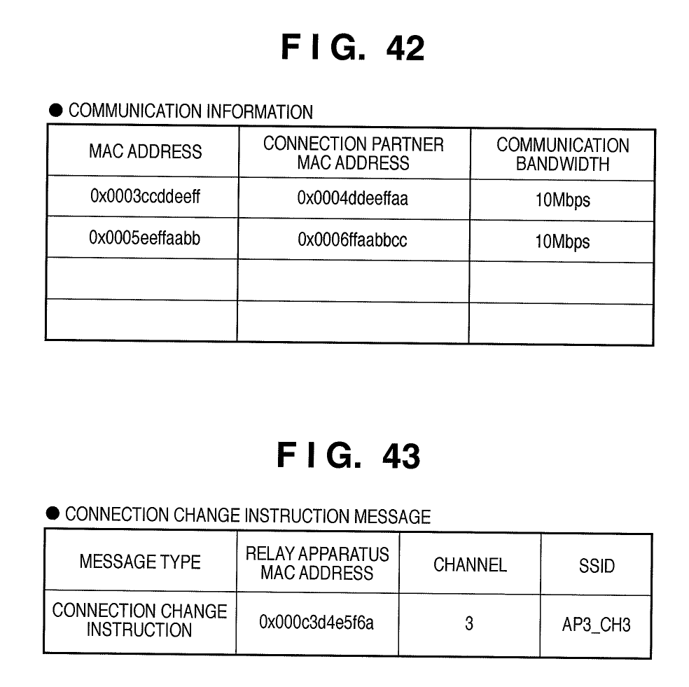

After communication information registration, the communication apparatuses (STA3 and STA4) start data communication (F3614). The communication apparatuses (STA5 and STA6) also start data communication (F3615). FIG. 42 shows an example of communication information managed by the communication information management unit 37 of the management apparatus 30. As described above, communication information includes the MAC address of the communication apparatus, the MAC address of the partner communication apparatus, and the communication bandwidth to be used.

The communication apparatus (STA1) 10 transmits an efficiency promotion request message to the management apparatus 30 (F3616). The efficiency promotion request message in the process of F3616 has the same contents as in FIG. 10.

Upon receiving the efficiency promotion request message, the management apparatus 30 executes communication path determination processing, and then transmits an efficiency promotion response message to the communication apparatus (STA1) 10 of the efficiency promotion request message transmission source (F3617). The efficiency promotion response message transmitted here has the same contents as in FIG. 25 and sets “connection destination change”.

The outline of the communication path determination processing will briefly be described. As is apparent from the relay apparatus information described with reference to FIG. 38 and the connection information described with reference to FIG. 40, two relay apparatuses exist on the communication path between the communication apparatuses (STA1 and STA2). Additionally, two frequency channels, that is, channel 1 and channel 2 are used between the two communication apparatuses. The communication path is changed to use one relay apparatus on the communication path between the communication apparatuses (STA1 and STA2) and also use one frequency channel for the communication. The relay apparatuses (AP1 and AP2) 20 serving as transit points between the communication apparatuses (STA1 and STA2) are compared. The number of channels is smaller in the relay apparatus (AP2) 20. Hence, the relay apparatus (AP2) 20 is selected as a connection destination candidate. However, the relay apparatus (AP2) 20 is used for the communication between the communication apparatuses (STA5 and STA6) and has no extra communication bandwidth (a free bandwidth of a predetermined range or more). Hence, the relay apparatus (AP3) 20 having an extra communication bandwidth is selected as the transit point so that the connection destination relay apparatus of the communication apparatus (STA1) 10 of the efficiency promotion request message transmission source changes. For this reason, “change” is set in the connection destination change of the efficiency promotion response message.

After transmitting the efficiency promotion response message, the management apparatus 30 transmits a connection change instruction message to the communication apparatuses (STA1 and STA2) (F3618 and F3619). FIG. 43 shows an example of the data structure of the connection change instruction message. The connection change instruction message shown in FIG. 43 sets “connection change instruction” in the message type, “0x000c3d4e5f6a” in the MAC address of the relay apparatus, “3” in the frequency channel, and “AP3_CH3” in the SSID.

Upon receiving the connection change instruction message, the communication apparatus (STA1) 10 is disconnected from the relay apparatus (AP1) 20 (F3620) and connected to the relay apparatus (AP3) 20 (F3621). Similarly, upon receiving the connection change instruction message, the communication apparatus (STA2) 10 is disconnected from the relay apparatus (AP2) 20 (F3622) and connected to the relay apparatus (AP3) 20 (F3623). The communication apparatuses (STA1 and STA2) then start data communication (F3624).

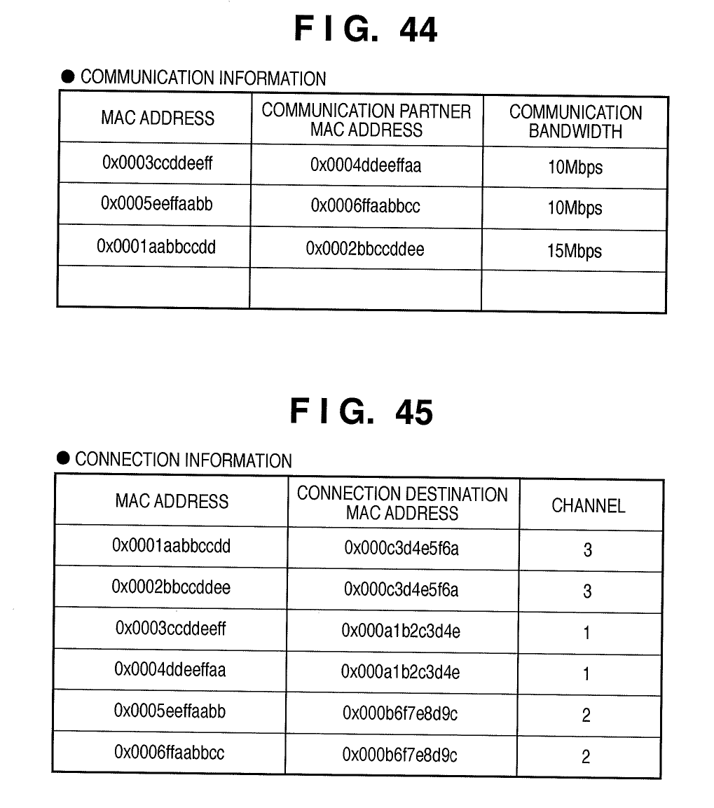

After transmitting the efficiency promotion response message, the management apparatus 30 updates communication information managed by the communication information management unit 37. FIG. 44 shows an example of the communication information. As described above, the communication information includes the MAC address of the communication apparatus, the MAC address of the partner communication apparatus, and the communication bandwidth to be used. FIG. 45 shows an example of connection information managed by the connection information management unit 36 of the management apparatus 30 after the above-described communication path change.

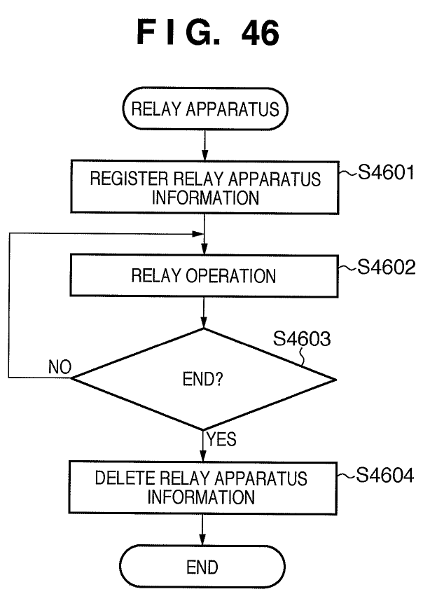

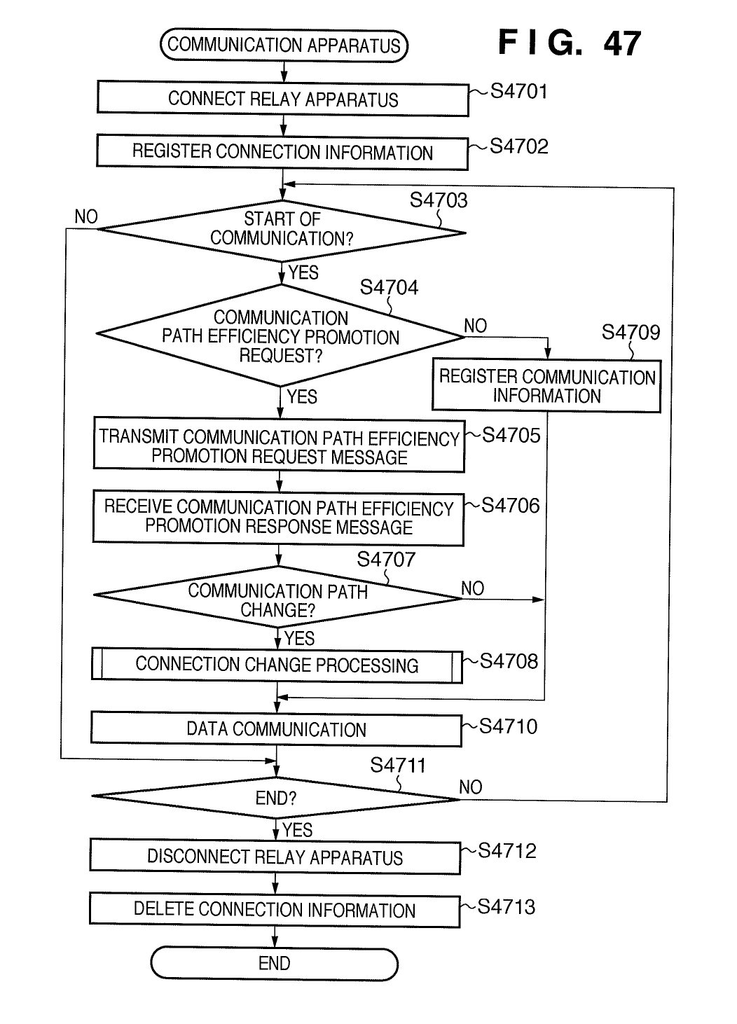

The sequence of the operation of each apparatus in the communication path control system shown in FIG. 1 will be described next with reference to the flowcharts in FIGS. 46 to 53.

The operation of the relay apparatus 20 will be described with reference to FIG. 46.

When the processing starts, the relay apparatus 20 executes relay apparatus information registration processing. In this processing, the relay apparatus information registration unit 25 transmits a relay apparatus information registration message to the management apparatus 30, thereby registering, in the management apparatus 30, information about wireless communication of the relay apparatus 20 (S4601).

When the communication apparatuses 10 are connected, the relay apparatus 20 causes the relay control unit 26 to perform a relay operation between the communication apparatuses (S4602). Then, the relay apparatus 20 determines whether to end the relay operation. This determination is done continuously during the relay operation (NO in step S4603). To end the relay operation (YES in step S4603), the relay apparatus 20 causes the relay apparatus information registration unit 25 to request the management apparatus 30 to delete the relay apparatus information registered in the process of step S4601 (S4604), and ends the relay operation.

The operation of the communication apparatus 10 will be described next with reference to FIG. 47.

When the processing starts, the communication apparatus 10 is connected to the relay apparatus 20 to communicate with the management apparatus 30 or another communication apparatus 10 (S4701). The communication apparatus 10 causes the connection information registration unit 15 to transmit a connection information registration message to the management apparatus 30, thereby registering, in the management apparatus 30, information about wireless communication with the relay apparatus 20 connected in the process of step S4701 (S4702).

After that, the communication apparatus 10 determines whether to start communication with the communication partner apparatus. If communication is not to be started (NO in step S4703), the process advances to step S4711. To start communication with the communication partner apparatus (YES in step S4703), the communication apparatus 10 causes the communication control unit 18 to determine whether to request communication path efficiency promotion of the management apparatus 30. If whether to request efficiency promotion is set by, for example, the apparatus settings, the efficiency promotion request is executed based on the information. Alternatively, the request may be executed upon detecting that the transmission speed has reduced to a predetermined value or less.

If the efficiency promotion request is not to be output (NO in step S4704), the communication apparatus 10 causes the communication information registration unit 16 to transmit a communication information registration message to the management apparatus 30, thereby registering, in the management apparatus 30, information about communication between the communication apparatuses (S4709). Then, the communication apparatus 10 starts data communication (S4710).

On the other hand, to request communication path efficiency promotion (YES in step S4704), the communication apparatus 10 causes the request unit 17 to transmit an efficiency promotion request message to the management apparatus 30 (S4705). Upon receiving an efficiency promotion response message corresponding to the request (S4706), the communication apparatus 10 causes the communication control unit 18 to determine, by referring to the message, whether the communication path should be changed. If the communication path should not be changed (NO in step S4707), the communication apparatus 10 starts data communication (S4710). If the communication path should be changed (YES in step S4707), the communication apparatus 10 executes connection change processing (to be described later in detail) to change the connection destination relay apparatus (S4708). Then, the communication apparatus 10 starts data communication (S4710).

To perform another operation after the data communication (NO in step S4711), the communication apparatus 10 returns to the process in step S4703. Note that the communication apparatus 10 requests the management apparatus 30 to delete the communication information at the end of data communication.

Upon determining in step S4711 to end the operation (YES in step S4711), the communication apparatus 10 causes the communication control unit 18 to disconnect the relay apparatus 20 (S4712). The communication apparatus 10 causes the connection information registration unit 15 to request the management apparatus 30 to delete the connection information registered in the process of step S4701 (S4713), and ends the processing.

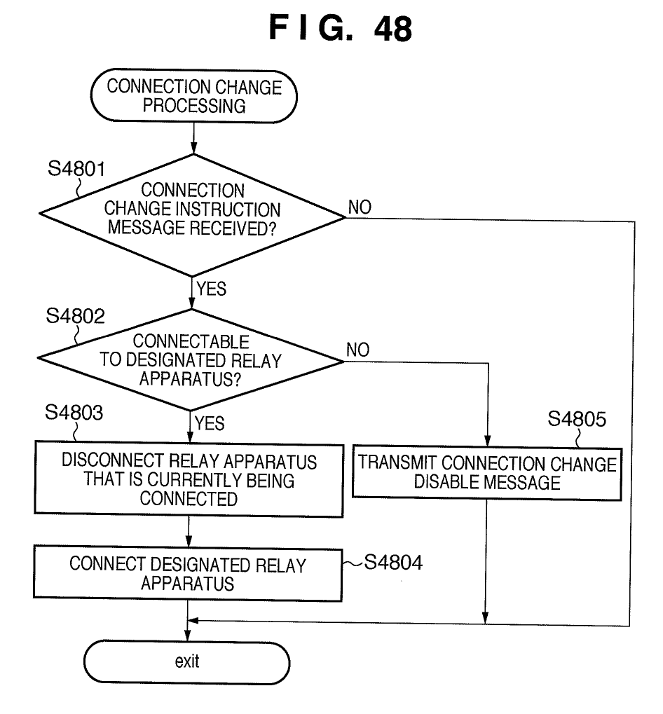

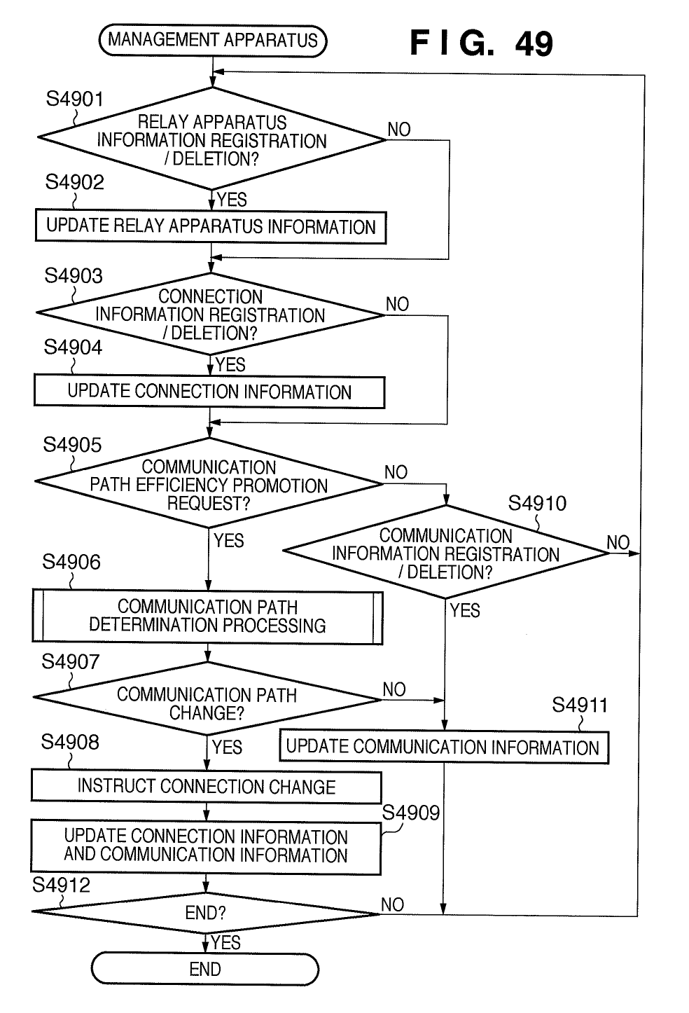

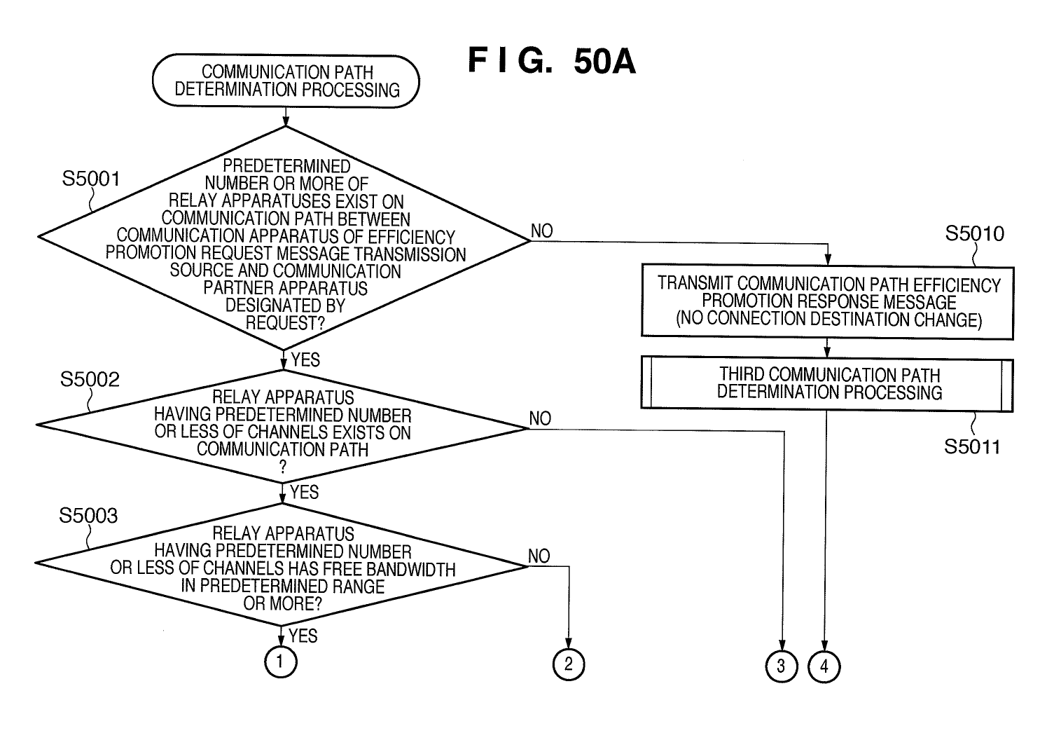

Details of the operation of the connection change processing in step S4708 of FIG. 47 will be described with reference to FIG. 48.

When the connection change processing starts, the communication apparatus 10 causes the communication control unit 18 to determine whether a connection change instruction message is received from the management apparatus 30. If no connection change instruction message is received (NO in step S4801), the processing directly ends. If a connection change instruction message is received (YES in step S4801), the communication apparatus 10 causes the communication control unit 18 to determine whether connection to the relay apparatus 20 designated in the connection change instruction message is possible. This determination is done in, for example, a wireless LAN environment based on whether the communication apparatus can receive beacons from the relay apparatus 20 designated in the connection change instruction message.

If it is determined that connection to the designated relay apparatus 20 is impossible (NO in step S4802), the communication apparatus 10 causes the communication control unit 18 to transmit a message representing the connection change disable state to the management apparatus 30 (S4805), and ends the processing. If connection to the designated relay apparatus 20 is possible (YES in step S4802), the communication apparatus 10 disconnects the relay apparatus 20 that is currently being connected (S4803). The communication apparatus 10 changes the connection to the relay apparatus 20 designated in the connection change instruction message (S4804), and ends the processing.

The operation of the management apparatus 30 will be described next with reference to FIG. 49.

When the processing starts, the management apparatus 30 determines whether a relay apparatus information registration or deletion request is received from the relay apparatus 20. Upon receiving a relay apparatus information registration or deletion request (YES in step S4901), the management apparatus 30 updates, based on the request, relay apparatus information managed by the relay apparatus information management unit 35 (S4902), and the process advances to step S4903.

If no relay apparatus information registration or deletion request is received (NO in step S4901), the management apparatus 30 determines whether a connection information registration or deletion request is received from the communication apparatus 10. Upon receiving a connection information registration or deletion request (YES in step S4903), the management apparatus 30 updates, based on the request, connection information managed by the connection information management unit 36 (S4904), and the process advances to step S4905.

If no connection information registration or deletion request is received (NO in step S4903), the management apparatus 30 determines whether a communication path efficiency promotion request is received from the communication apparatus 10. If no communication path efficiency promotion request is received (NO in step S4905), the management apparatus 30 determines whether a communication information registration or deletion request is received from the communication apparatus 10. If no communication information registration or deletion request is received (NO in step S4910), the management apparatus 30 returns to the process in step S4901. On the other hand, upon receiving a communication information registration or deletion request (YES in step S4910), the management apparatus 30 updates communication information managed by the communication information management unit 37 (S4911), and returns to the process in step S4901.

Upon receiving a communication path efficiency promotion request from the communication apparatus 10 in step S4905 (YES in step S4905), the management apparatus 30 causes the communication path determination unit 38 to execute communication path determination processing (to be described later in detail) (S4906). If the connection destination relay apparatus of the communication apparatus should not be changed as the result of processing (NO in step S4907), the management apparatus 30 updates communication information managed by the communication information management unit 37 (S4911), and returns to the process in step S4901. If the connection destination relay apparatus of the communication apparatus 10 should be changed (YES in step S4907), the management apparatus 30 causes the communication path control unit 39 to control the communication path based on the result of the communication path determination processing. More specifically, the management apparatus 30 transmits a connection change instruction message to the communication apparatus 10 which requires a connection destination change (S4908).

After transmitting the message, the management apparatus 30 updates the connection information managed by the connection information management unit 36 and the communication information managed by the communication information management unit 37 (S4909). Note that upon receiving a connection change disable message from the communication apparatus 10, the management apparatus 30 does not change the connection information about the communication apparatus of the message transmission source.

Then, the management apparatus 30 determines whether to end its operation. To end the operation (YES in step S4912), the management apparatus 30 directly ends the processing. To continue the operation (NO in step S4912), the management apparatus 30 returns to the process in step S4901.

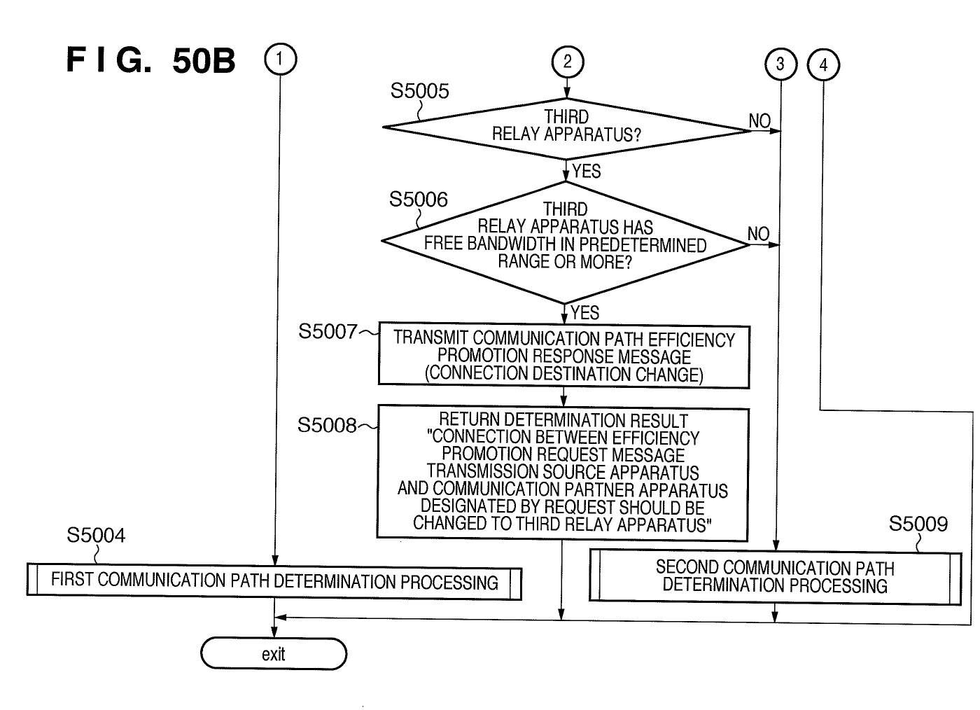

Details of the operation of the communication path determination processing in step S4906 of FIG. 49 will be described with reference to FIGS. 50A and 50B.

When the processing starts, the management apparatus 30 determines whether a predetermined number (e.g., two) or more of relay apparatuses exist between the communication apparatus of the efficiency promotion request message transmission source and the communication partner apparatus designated by the request. If the number of relay apparatuses is smaller than the predetermined number (NO in step S5001), the management apparatus 30 transmits an efficiency promotion response message (no connection destination change) to the communication apparatus 10 of the efficiency promotion request message transmission source (S5010). After that the management apparatus 30 executes third communication path determination processing (S5011), and ends the processing.

Upon determining in step S5001 that a predetermined number or more of relay apparatuses exist (YES in step S5001), the management apparatus 30 determines whether the relay apparatuses 20 on the communication path include a relay apparatus having a predetermined number (e.g., one) or less of channels. This determination is performed to prefer, as a transit point, a relay apparatus having a smaller number of channels to one having a larger number of channels and avoid a decrease in the transmission speed caused by channel switching, as described above.

Upon determining that there is no relay apparatus 20 having the predetermined number or less of channels (NO in step S5002), the management apparatus 30 executes second communication path determination processing (S5009), and ends the processing.

Upon determining in step S5002 that there is the relay apparatus 20 having the predetermined number or less of channels (YES in step S5002), the management apparatus 30 determines whether the relay apparatus 20 having the predetermined number or less of channels has a free bandwidth of a predetermined range or more. Whether the relay apparatus has a free bandwidth of a predetermined range or more is determined based on, for example, a threshold defined in advance. If a free bandwidth of a predetermined range or more exists (YES in step S5003), the management apparatus 30 executes first communication path determination processing (S5004), and ends the processing. If no free bandwidth of a predetermined range or more exists (NO in step S5003), the management apparatus 30 determines whether there is another relay apparatus that is not located on the communication path between the communication apparatus of the efficiency promotion request message transmission source and the communication partner apparatus designated by the request. This relay apparatus will be referred to as a third relay apparatus hereinafter. If no third relay apparatus exists (NO in step S5005), the management apparatus 30 executes second communication path determination processing (S5009), and ends the processing.

Upon determining in step S5005 that there is a third relay apparatus (YES in step S5005), the management apparatus 30 determines whether the relay apparatus has a free bandwidth of a predetermined range or more. If no free bandwidth of a predetermined range or more exists (NO in step S5006), the management apparatus 30 executes second communication path determination processing (S5009), and ends the processing. If a free bandwidth of a predetermined range or more exists (YES in step S5006), the management apparatus 30 transmits an efficiency promotion response message (connection destination change) to the efficiency promotion request message transmission source apparatus (S5007). After that, the management apparatus 30 causes the communication path determination unit 38 to return a determination result “connection between the efficiency promotion request message transmission source apparatus and the communication partner apparatus designated by the request should be changed to the third relay apparatus” (S5008), and ends the processing.

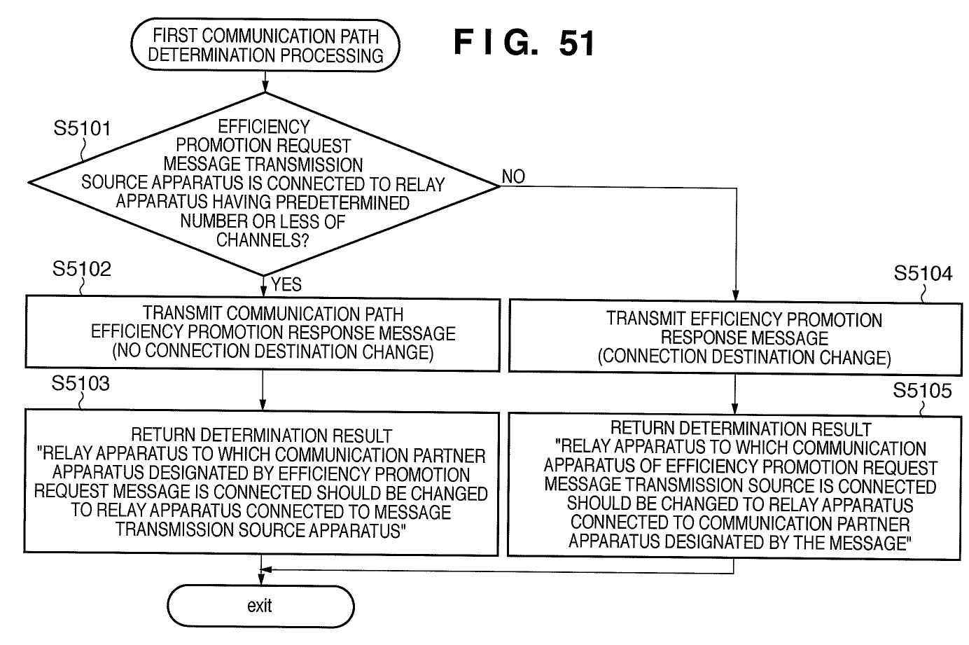

Details of the operation of the first communication path determination processing in step S5004 of FIG. 50B will be described next with reference to FIG. 51. In this processing, the connection destination relay apparatus of the communication apparatus 10 changes to a relay apparatus having a predetermined number or less of channels.

When the processing starts, the management apparatus 30 determines whether the communication apparatus of the efficiency promotion request message transmission source is connected to the relay apparatus 20 having a predetermined number (e.g., one) or less of channels. If the communication apparatus is connected to the relay apparatus 20 having the predetermined number or less of channels (YES in step S5101), the management apparatus 30 transmits an efficiency promotion response message (no connection destination change) to the message transmission source apparatus (S5102). The management apparatus 30 causes the communication path determination unit 38 to return a determination result “the relay apparatus to which the communication partner apparatus designated by the efficiency promotion request message is connected should be changed to the relay apparatus connected to the message transmission source apparatus” (S5103). The management apparatus 30 then ends the processing.

If the efficiency promotion request message transmission source apparatus is not connected to the relay apparatus having the predetermined number or less of channels (NO in step S5101), the management apparatus 30 transmits an efficiency promotion response message to the message transmission source apparatus (S5104). Note that “connection destination change” is set in the efficiency promotion response message. The management apparatus 30 causes the communication path determination unit 38 to return a determination result “the relay apparatus to which the communication apparatus of the efficiency promotion request message transmission source is connected should be changed to the relay apparatus connected to the communication partner apparatus designated by the message” (S5105). The management apparatus 30 then ends the processing.

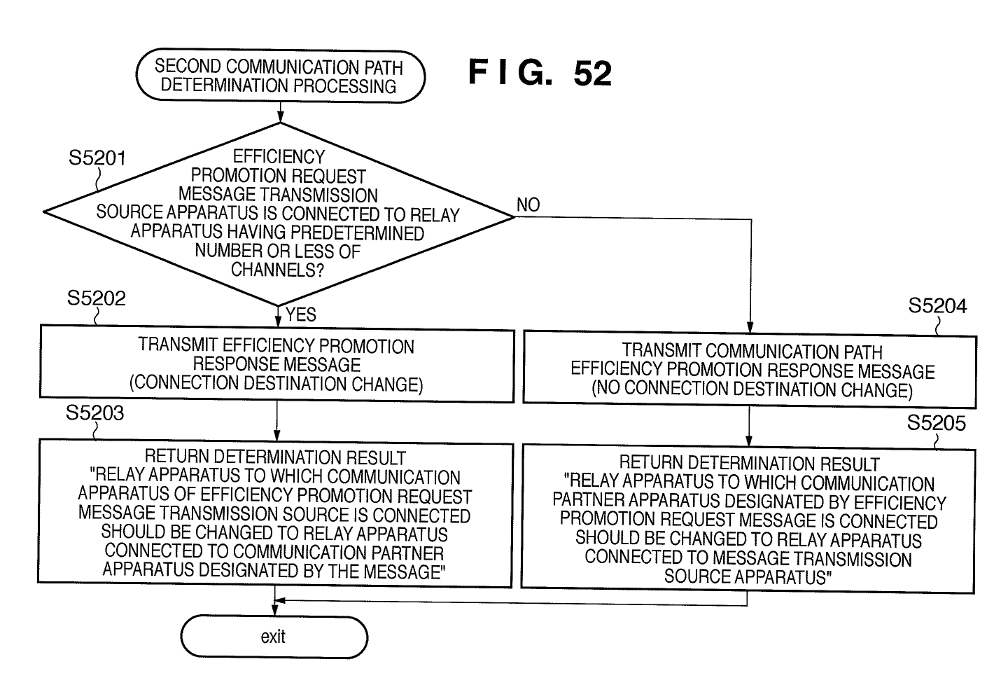

Details of the operation of the second communication path determination processing in step S5009 of FIG. 50B will be described next with reference to FIG. 52. In this processing, the connection destination relay apparatus of the communication apparatus 10 changes to a relay apparatus having channels more than a predetermined number.

When the processing starts, the management apparatus 30 determines whether the communication apparatus of the efficiency promotion request message transmission source is connected to the relay apparatus 20 having a predetermined number (e.g., one) or less of channels. If the communication apparatus is connected to the relay apparatus 20 having the predetermined number or less of channels (YES in step S5201), the management apparatus 30 transmits a communication path efficiency promotion response message (connection destination change) to the message transmission source apparatus (S5202). The management apparatus 30 causes the communication path determination unit 38 to return a determination result “the relay apparatus to which the communication apparatus of the efficiency promotion request message transmission source is connected should be changed to the relay apparatus connected to the communication partner apparatus designated by the message” (S5203). The management apparatus 30 then ends the processing.

If the efficiency promotion request message transmission source apparatus is not connected to the relay apparatus having the predetermined number or less of channels (NO in step S5201), the management apparatus 30 transmits an efficiency promotion response message (no connection destination change) to the message transmission source apparatus (S5204). The management apparatus 30 causes the communication path determination unit 38 to return a determination result “the relay apparatus to which the communication partner apparatus designated by the efficiency promotion request message is connected should be changed to the relay apparatus connected to the message transmission source apparatus” (S5205). The management apparatus 30 then ends the processing.

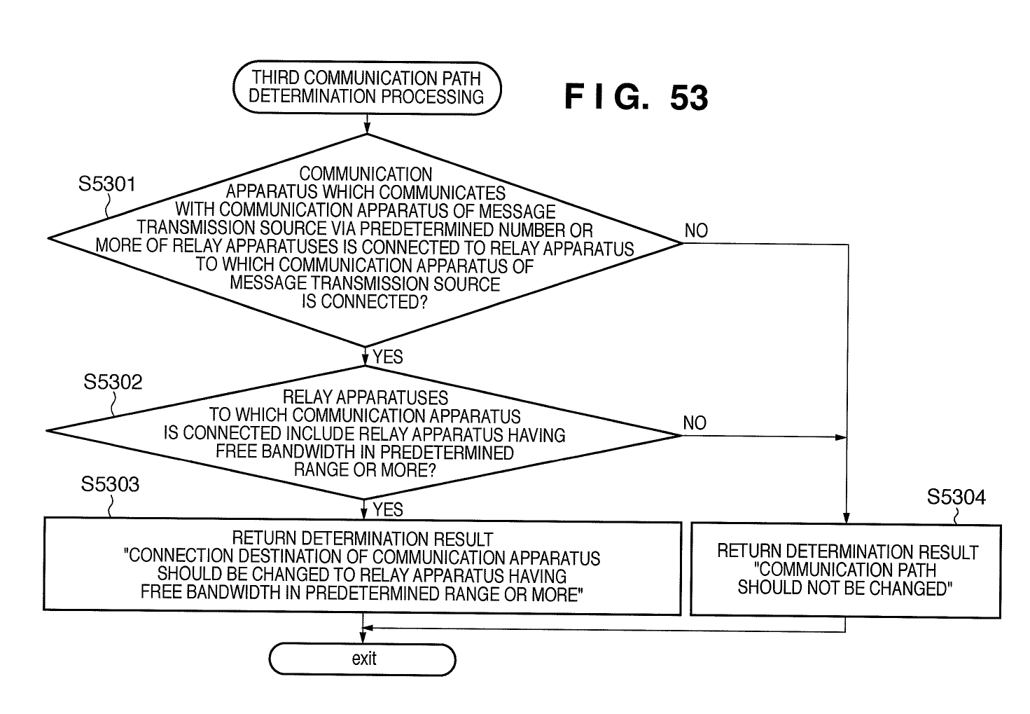

Details of the operation of the third communication path determination processing in step S5011 of FIG. 50A will be described next with reference to FIG. 53.

When the processing starts, the management apparatus 30 determines whether another communication apparatus which communicates with the communication apparatus of the message transmission source via a predetermined number or more of relay apparatuses is connected to the relay apparatus to which the communication apparatus of the message transmission source is connected.

If no such a communication apparatus exists (NO in step S5301), the management apparatus 30 causes the communication path determination unit 38 to return a determination result “the communication path should not be changed” (S5304), and ends the processing. If such a communication apparatus exists (YES in step S5301), the management apparatus 30 determines whether the relay apparatuses 20 to which the communication apparatus is connected include a relay apparatus 20 having a free bandwidth of a predetermined range or more. If no relay apparatus 20 having a free bandwidth of a predetermined range or more exists (NO in step S5302), the management apparatus 30 causes the communication path determination unit 38 to return a determination result “the communication path should not be changed” (S5304), and ends the processing. If the relay apparatus 20 having a free bandwidth of a predetermined range or more exists (YES in step S5302), the management apparatus 30 causes the communication path determination unit 38 to return a determination result “the connection destination of the communication apparatus should be changed to the relay apparatus having a free bandwidth of a predetermined range or more” (S5303), and ends the processing.

The above description of FIGS. 50A and 50B to 53 has not mentioned any processing of decreasing the number of channels used by the relay apparatus 20. However, this processing is executed as needed when changing the communication path, as described with reference to FIGS. 5 to 45.

An example of the typical embodiment of the present invention has been described above. The present invention is not limited to the above-described embodiment shown in the drawings, and changes and modifications can be made as needed without departing from the spirit and scope of the present invention.

For example, in the description of FIG. 50A, communication path control is done by determining the number of relay apparatuses (S5001), the number of channels of each relay apparatus (S5002), and the communication bandwidth of each relay apparatus (S5003). The order of determinations may be changed. Instead of performing all determinations, one of them may selectively be performed.

In the above description, a relay apparatus having a smaller number of channels is preferentially selected as a transit point. This aims at avoiding a decrease in the transmission speed caused by channel switching, as described above. Any other information may be determined if a relay apparatus with less or no channel switching is selectable.

The present invention can take a form of, for example, a system, apparatus, method, program, or storage medium. More specifically, the present invention is applicable to a system including a plurality of devices, or an apparatus including a single device.

The present invention also incorporates a case in which the functions of the above-described embodiment are achieved by supplying a software program to the system or apparatus directly or from a remote site and causing the computer of the system or apparatus to read out and execute the supplied program code. In this case, the supplied program is a computer program corresponding to the flowcharts illustrated in the embodiment.

Hence, the program code itself, which is installed in the computer to implement the functional processing of the present invention by the computer, also implements the present invention. That is, the present invention incorporates the computer program itself for implementing the functional processing of the present invention. In this case, the program can take any form such as an object code, a program to be executed by an interpreter, or script data to be supplied to the OS (Operating System) as long as the functions of the program can be obtained.

Examples of the computer-readable storage medium to supply the computer program are a floppy® disk, hard disk, optical disk, magnetooptical disk, MO, CD-ROM, CD-R, CD-RW, magnetic tape, nonvolatile memory card, ROM, and DVD (DVD-ROM or DVD-R).

As another program supply method, a client computer may be connected to a homepage on the Internet by using a browser to download the computer program of the present invention from the homepage to a recording medium such as a hard disk. In this case, the program to be downloaded may be a compressed file containing an automatic installation function. The program code contained in the program of the present invention may be divided into a plurality of files, and the files may be downloaded from different homepages. That is, the present invention also incorporates a WWW server which causes a plurality of users to download a program file that implements the functional processing of the present invention by a computer.

The program of the present invention may be encrypted, stored in a storage medium such as a CD-ROM, and delivered to users. Any user who satisfies predetermined conditions may be allowed to download key information for decryption from a homepage via the Internet so that he/she can execute the encrypted program by using the key information and install the program in the computer.

The functions of the above-described embodiment can be implemented not only when the computer executes the readout program but also in cooperation with, for example, the OS running on the computer based on the instructions of the program. In this case, the OS or the like partially or wholly executes actual processing, thereby implementing the functions of the above-described embodiment.

Alternatively, some or all of the functions of the above-described embodiment may be implemented by writing the program read out from the recording medium in the memory of a function expansion board inserted into the computer or a function expansion unit connected to the computer. In this case, after the program is written in the function expansion board or function expansion unit, the CPU of the function expansion board or function expansion unit partially or wholly executes actual processing based on the instructions of the program.

According to the present invention, since load on a relay apparatus is reduced by controlling the communication path between communication apparatuses via the relay apparatus, it is possible to increase the speed of communication between the communication apparatuses.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-070052, filed Mar. 18, 2008, which is hereby incorporated by reference herein in its entirety.

What is claimed is:

1. A management apparatus for managing a plurality of relay apparatuses and a plurality of communication apparatuses which communicate via the relay apparatuses, comprising:
a first management unit configured to manage relay apparatus information about communication of each of the relay apparatuses;
a second management unit configured to manage connection information about connection between each of the communication apparatuses and a relay apparatus to which the communication apparatus is connected; and
a control unit configured to control change of a communication path between the communication apparatuses based on information including the relay apparatus information managed by said first management unit and the connection information managed by said second management unit.

2. The apparatus according to claim 1, wherein said control unit controls change of the communication path based on at least one of the number of relay apparatuses, the number of channels of each relay apparatus, and a communication bandwidth usable by each relay apparatus, on the communication path between the communication apparatuses.

3. The apparatus according to claim 1, wherein
the communication apparatus comprises a request unit configured to request promotion of efficiency of a communication path to a communication partner apparatus, and
said control unit controls change of the communication path in response to a request from said request unit.

4. The apparatus according to claim 3, wherein if the number of relay apparatuses on a communication path between a communication apparatus which has caused said request unit to request promotion of efficiency of the communication path and a communication partner apparatus designated by the request is smaller than a predetermined number, the number of relay apparatuses on an another communication path between another communication apparatus connected to a relay apparatus on the communication path and the communication apparatus which has requested promotion of efficiency is not less than the predetermined number, and the relay apparatuses on the another communication path include a relay apparatus having a free communication bandwidth not less than a predetermined range, said control unit changes the another communication path to perform communication via the relay apparatus which has a free communication bandwidth not less than a predetermined range.

5. The apparatus according to claim 3, wherein if the number of relay apparatuses on a communication path between a communication apparatus which has caused said request unit to request promotion of efficiency of the communication path and a communication partner apparatus designated by the request is not less than a predetermined number, and the relay apparatuses include a relay apparatus having not more than a predetermined number of channels and a free communication bandwidth not less than a predetermined range, said control unit changes the communication path of one of the communication apparatus which has requested promotion of efficiency and the designated communication partner apparatus to perform communication via the relay apparatus which has not more than a predetermined number of channels and has a free communication bandwidth not less than a predetermined range.

6. The apparatus according to claim 3, wherein if the number of relay apparatuses on a communication path between a communication apparatus which has caused said request unit to request promotion of efficiency of the communication path and a communication partner apparatus designated by the request is not less than a predetermined number, and each of the relay apparatuses does not have a free communication bandwidth not less than a predetermined range, said control unit changes the communication paths of the communication apparatus which has requested promotion of efficiency and the designated communication partner apparatus to perform communication via another relay apparatus which is not located on the communication path and has a free communication bandwidth not less than a predetermined range.

7. The apparatus according to claim 1, wherein said control unit instructs to change a relay apparatus that is a connection destination of a communication apparatus to request change of the communication path.

8. The apparatus according to claim 1, wherein said control unit decreases the number of channels to be used by a relay apparatus on the communication path between the communication apparatuses upon changing the communication path.

9. The apparatus according to claim 1, wherein the relay apparatus information includes at least one of identification information of a relay apparatus, a frequency channel and an SSID to be used by the relay apparatus, and a bandwidth of the relay apparatus.

10. The apparatus according to claim 1, wherein the connection information includes at least one of identification information of a communication apparatus, identification information of a relay apparatus that is a connection destination of the communication apparatus, and a channel to be used.

11. The apparatus according to claim 1, wherein
the relay apparatus comprises a first registration unit configured to register, in the management apparatus, relay apparatus information about communication of the relay apparatus, and
said first management unit manages the relay apparatus information registered by said first registration unit.

12. The apparatus according to claim 1, wherein
the communication apparatus comprises a second registration unit configured to register, in the management apparatus, connection information about connection to a relay apparatus to which the communication apparatus is connected, and
said second management unit manages the connection information registered by said second registration unit.

13. A communication path control method of a management apparatus for managing a plurality of relay apparatuses and a plurality of communication apparatuses which communicate via the relay apparatuses, comprising:
managing relay apparatus information about communication of each of the relay apparatuses;
managing connection information about connection between each of the communication apparatuses and a relay apparatus to which the communication apparatus is connected; and
controlling change of a communication path between the communication apparatuses based on information including the relay apparatus information and the connection information.

14. A communication path control system including a plurality of relay apparatuses, a plurality of communication apparatuses which communicate via the relay apparatuses, and a management apparatus,
the management apparatus comprising:
a first management unit configured to manage relay apparatus information about communication of each of the relay apparatuses;
a second management unit configured to manage connection information about connection between each of the communication apparatuses and a relay apparatus to which the communication apparatus is connected; and
a control unit configured to control change of a communication path between the communication apparatuses based on information including the relay apparatus information managed by said first management unit and the connection information managed by said second management unit.

15. A computer-readable storage medium storing a communication path control program which causes a computer incorporated in a management apparatus for managing a plurality of relay apparatuses and a plurality of communication apparatuses which communicate via the relay apparatuses to function as:
a first management unit configured to manage relay apparatus information about communication of each of the relay apparatuses;
a second management unit configured to manage connection information about connection between each of the communication apparatuses and a relay apparatus to which the communication apparatus is connected; and
a control unit configured to control change of a communication path between the communication apparatuses based on information including the relay apparatus information managed by the first management unit and the connection information managed by the second management unit.
